(19) United States
(12) Patent Application Publication
(10) Pub. No.: US 2025/0343351 A1
(43) Pub. Date: Nov. 6, 2025

(54) ANTENNA DEVICE

(71) Applicant: KMW INC., Hwaseong-si (KR)

(72) Inventors: Duk Yong KIM, Yongin-si (KR); Chang Woo YOO, Hwaseong-si (KR); Myong Sik LEE, Suwon-si (KR); Chi Back RYU, Hwaseong-si (KR); Dae Myung PARK, Hwaseong-si (KR); Hee KIM, Osan-si (KR); In Hwa CHOI, Yongin-si (KR)

(73) Assignee: KMW INC., Hwaseong-si (KR)

(21) Appl. No.: 19/271,930

(22) Filed: Jul. 17, 2025

Related U.S. Application Data
(63) Continuation of application No. PCT/KR2024/000925, filed on Jan. 19, 2024.

(30) Foreign Application Priority Data
Jan. 19, 2023 (KR) 10-2023-0008054
Jan. 18, 2024 (KR) 10-2024-0008333

(51) Int. Cl. H01Q 3/06; H01Q 1/12; H01Q 1/24

(52) U.S. Cl. CPC H01Q 3/06; H01Q 1/1228; H01Q 1/125; H01Q 1/246

(57) ABSTRACT

An antenna device is provided that may facilitate the operation of a tilt driving unit by reducing the weight of the tilt driving unit for tilting an antenna unit while ensuring sufficient rigidity. To this end, the antenna device according to the present disclosure includes an antenna unit; and a tilt driving unit having a plurality of tilt members configured to tilt the antenna unit when rotated, and a plurality of joint bars configured to rotatably couple both ends of each of the plurality of tilt members, the tilt driving unit configured to couple the antenna unit to a support pole; wherein the plurality of joint bars are formed in a hollow pipe shape.

### CROSS-REFERENCE TO RELATED APPLICATIONS

This application is a continuation application of International Application No. PCT/KR2024/000925, filed Jan. 19, 2024 claims the benefit of Korean Patent Applications No. 10-2023-0008054, filed Jan. 19, 2023, and No. 10-2024-0008333, filed Jan. 18, 2024 in the Korean Intellectual Property Office, the disclosures of which are incorporated herein in their entirety by reference.

### TECHNICAL FIELD

The present disclosure relates to an antenna device, and more particularly, to a multiple-input multiple-output (MIMO) antenna device used in wireless communication technology such as mobile communication terminals.

### BACKGROUND ART

Wireless communication technology, for example, multiple-input multiple-output (MIMO) technology, is a technology that dramatically increases data transmission capacity by using multiple antennas. It is a spatial multiplexing technique where a transmitter transmits different data through respective transmitting antennas, and a receiver distinguishes the transmitted data through appropriate signal processing.

Therefore, by simultaneously increasing the number of transmitting and receiving antenna units, channel capacity increases, enabling more data to be transmitted. For example, increasing the number of antennas to 10 secures approximately 10 times the channel capacity compared to the current single antenna system, using the same frequency band.

4G LTE-advanced uses up to 8 antennas, and products equipped with 64 or 128 antennas have been developed in the pre-5G stage. As wireless communication technology advances, base station equipment with a much larger number of antennas is expected to be used, which is called Massive MIMO technology. This Massive MIMO technology is also referred to as full dimension (FD)-MIMO because it enables 3D-Beamforming compared to the conventional 2-Dimension Cell operating method.

In Massive MIMO technology, as the number of ANT increases, the number of transmitters and filters also increases. Nevertheless, due to lease costs and spatial constraints of installation sites, when installing MIMO antennas, where RF components (Antenna/Filter/Power Amplifier/Transceiver etc.) and digital components are combined in a stacked structure, there is a need for compact and miniaturized designs for multiple layers constituting the MIMO antenna to maximize ease of installation and space utilization.

In addition, the communication strength with a mobile communication terminal may vary depending on the directional direction of the antenna. Therefore, for base station antennas, it is necessary to adjust the tilting (vertical angle adjustment) or rotation (horizontal angle adjustment) of the antenna to resolve shadow areas, thereby varying the direction of signals transmitted and received by the antenna.

As a technology for adjusting the directional direction of the antenna, U.S. Patent Publication U.S. Ser. No. 10/511,090 B2 (2019 Dec. 17.) (hereinafter referred to as ‘prior art’) discloses a ‘Wireless telecommunication antenna mount and control system’.

The prior art is an antenna mount for use with a telecommunication antenna having at least one AISG antenna control unit (ACU), wherein the antenna mount includes a structure interface mounted on an installation structure, an antenna interface mounted on the antenna and rotatably connected to the structure interface via a pivot having a vertical axis, and movable rotatably about the vertical axis through a range of azimuth positions, and a mount azimuth control unit (MACU) mechanically interconnected between the structure interface and the antenna interface, having a motor, an AISG-compatible motor controller, a male bidirectional AISG port, and a female bidirectional AISG port, and capable of controlling the motor to drive the rotatable movement of the antenna through the range of azimuth positions, wherein the ACU and the MACU are both serially connected to each other via the bidirectional AISG ports to an AISG control interface for serial remote control, and the mount further includes a mechanical down-tilt assembly mechanically interconnected between the antenna interface and the antenna, wherein the mechanical down-tilt assembly includes a lower hinge connector connected between a lower portion of the antenna interface and a lower portion of the antenna, and the lower hinge connector is rotatable about a horizontal axis, and the mechanical down-tilt assembly further includes an upper down-tilt bracket connected between an upper portion of the antenna interface and an upper portion of the antenna, and the upper down-tilt bracket is configured to pivot the antenna relative to the lower hinge connector through a range of tilt angle positions.

However, the mechanical down-tilt assembly of the prior art is configured by rotatably coupling a plurality of scissor arms through a plurality of pivots, which had a problem in that the tilt operation was not smooth due to the weight of the plurality of scissor arms and the plurality of pivots. If the weight of the plurality of scissor arms and the plurality of pivots were to be unreasonably reduced, there could be a problem in that sufficient rigidity to support the antenna could not be secured.

### DISCLOSURE OF THE INVENTION

### Technical Problem

An object of the present disclosure is to provide an antenna device that may facilitate the operation of a tilt driving unit by reducing the weight of the tilt driving unit for tilting an antenna unit while ensuring sufficient rigidity.

Another object of the present disclosure is to provide an antenna device that may tilt an antenna unit manually or automatically.

The technical problems of the present disclosure are not limited to the problems mentioned above, and other unmentioned problems will be clearly understood by those skilled in the art from the description below.

### Technical Solution

To achieve the above object, an antenna device according to the present disclosure comprises an antenna unit and a tilt driving unit. The tilt driving unit couples the antenna unit to a support pole. The tilt driving unit has a plurality of tilt members and a plurality of joint bars. The plurality of tilt members tilt the antenna unit when rotated. The plurality of joint bars rotatably couple both ends of each of the plurality of tilt members. The plurality of joint bars are formed in a hollow pipe shape.

At least one bushing may be coupled to both ends of each of the plurality of tilt members. The plurality of joint bars may be rotatably coupled to the at least one bushing.

The plurality of tilt members may be formed in a hollow pipe shape.

Both ends of the plurality of joint bars may be coupled to the plurality of tilt members by a plurality of fixing fasteners.

Clip through-holes may be formed at both ends of the plurality of joint bars. The plurality of fixing fasteners may be formed as a plurality of clips. The plurality of clips may each pass through the clip through-holes formed at both ends of the plurality of joint bars. The plurality of clips may couple the plurality of joint bars to the plurality of tilt members, respectively.

Snap ring coupling grooves may be formed on the outer circumferential surface of both ends of the plurality of joint bars. The plurality of fixing fasteners may be formed as a plurality of snap rings. The plurality of snap rings may each be coupled to the snap ring coupling grooves formed on the outer circumferential surface of both ends of the plurality of joint bars. The plurality of snap rings may couple the plurality of joint bars to the plurality of tilt members, respectively.

The plurality of joint bars may consist of a first joint bar, a second joint bar, a third joint bar, and a fourth joint bar. The second joint bar may be spaced forward from the first joint bar. The second joint bar may be arranged parallel to the first joint bar. The third joint bar may be spaced upward or downward between the first joint bar and the second joint bar. The third joint bar may be arranged parallel to the first joint bar and the second joint bar. The fourth joint bar may be spaced in the opposite direction to the third joint bar between the first joint bar and the second joint bar. The fourth joint bar may be arranged parallel to the first joint bar, the second joint bar, and the third joint bar.

A support pole mounting unit may be coupled to the support pole. An antenna mounting unit may be coupled to the antenna unit. The first joint bar may be coupled to the support pole mounting unit. The second joint bar may be coupled to the antenna mounting unit.

The plurality of tilt members may consist of a first tilt member, a second tilt member, a third tilt member, and a fourth tilt member. Both ends of the first tilt member may be rotatably coupled to the first joint bar and the third joint bar, respectively. Both ends of the second tilt member may be rotatably coupled to the second joint bar and the third joint bar, respectively. Both ends of the third tilt member may be rotatably coupled to the first joint bar and the fourth joint bar, respectively. Both ends of the fourth tilt member may be rotatably coupled to the second joint bar and the fourth joint bar, respectively.

The first tilt member may consist of a 1-1 tilt member and a 1-2 tilt member. Both ends of the 1-1 tilt member may be rotatably coupled to one end of the first joint bar and one end of the third joint bar, respectively. Both ends of the 1-2 tilt member may be rotatably coupled to the other end of the first joint bar and the other end of the third joint bar, respectively. The second tilt member may consist of a 2-1 tilt member and a 2-2 tilt member. Both ends of the 2-1 tilt member may be rotatably coupled to one end of the second joint bar and one end of the third joint bar, respectively. Both ends of the 2-2 tilt member may be rotatably coupled to the other end of the second joint bar and the other end of the third joint bar, respectively. The third tilt member may consist of a 3-1 tilt member and a 3-2 tilt member. Both ends of the 3-1 tilt member may be rotatably coupled to one end of the first joint bar and one end of the fourth joint bar, respectively. Both ends of the 3-2 tilt member may be rotatably coupled to the other end of the first joint bar and the other end of the fourth joint bar, respectively. The fourth tilt member may consist of a 4-1 tilt member and a 4-2 tilt member. Both ends of the 4-1 tilt member may be rotatably coupled to one end of the second joint bar and one end of the fourth joint bar, respectively. Both ends of the 4-2 tilt member may be rotatably coupled to the other end of the second joint bar and the other end of the fourth joint bar, respectively.

The tilt driving unit may further include a nut member and a screw bar. The nut member may be positioned on either the third joint bar or the fourth joint bar. The screw bar may be vertically fastened to the nut member. The screw bar may rotate the first tilt member, the second tilt member, the third tilt member, and the fourth tilt member to tilt the antenna unit when rotated.

A first coupling frame in the shape of a hollow pipe may be placed in the nut member. A first through-hole, through which one of the aforementioned joint bars passes, may be formed on each side of the first coupling frame. A second through-hole, through which the screw bar passes, may be formed on the upper and lower sides of the first coupling frame. A third through-hole, through which the screw bar passes, may be formed in the aforementioned joint bar.

The tilt driving unit may further comprise a mounting bracket and a manual tilt adjustment member. The mounting bracket may be disposed on the other of the third joint bar and the fourth joint bar. The manual tilt adjustment member may be rotatably disposed on the mounting bracket. The manual tilt adjustment member may be coupled to one end of the screw bar.

A second coupling frame in the shape of a hollow pipe may be placed in the mounting bracket. A fourth through-hole, through which the other of the aforementioned joint bars passes, may be formed on each side of the second coupling frame. A fifth through-hole, through which the screw bar passes, may be formed on the lower side of the second coupling frame. A sixth through-hole, through which the manual tilt adjustment member passes, may be formed on the upper side of the second coupling frame. A seventh through-hole, through which the coupling part of the screw bar and the manual tilt adjustment member passes, may be formed in the other of the aforementioned joint bars.

The tilt driving unit may further include a tilt motor. The tilt motor may be mounted on the mounting bracket. The rotation axis of the tilt motor may be connected to the manual tilt adjustment member to rotate the screw bar.

The plurality of tilt members may be formed in a plate shape.

A plurality of bolts may be fastened to both ends of each of the plurality of joint bars. The plurality of bolts may couple the plurality of joint bars to the plurality of tilt members, respectively.

The plurality of joint bars may consist of a first joint bar, a second joint bar, and a third joint bar. The second joint bar may be spaced forward from the first joint bar. The second joint bar may be arranged parallel to the first joint bar. The third joint bar may be spaced upward or downward between the first joint bar and the second joint bar. The third joint bar may be arranged parallel to the first joint bar and the second joint bar.

A support pole mounting unit may be coupled to the support pole. An antenna mounting unit may be coupled to the antenna unit. The first joint bar may be coupled to the support pole mounting unit. The second joint bar may be coupled to the antenna mounting unit.

The plurality of tilt members may consist of a first tilt member and a second tilt member. Both ends of the first tilt member may be rotatably coupled to the first joint bar and the third joint bar, respectively. Both ends of the second tilt member may be rotatably coupled to the second joint bar and the third joint bar, respectively.

The first tilt member may consist of a 1-1 tilt member and a 1-2 tilt member. Both ends of the 1-1 tilt member may be rotatably coupled to one end of the first joint bar and one end of the third joint bar, respectively. Both ends of the 1-2 tilt member may be rotatably coupled to the other end of the first joint bar and the other end of the third joint bar, respectively. The second tilt member may consist of a 2-1 tilt member and a 2-2 tilt member. Both ends of the 2-1 tilt member may be rotatably coupled to one end of the second joint bar and one end of the third joint bar, respectively. Both ends of the 2-2 tilt member may be rotatably coupled to the other end of the second joint bar and the other end of the third joint bar, respectively.

The tilt driving unit may further include a first connecting plate and a second connecting plate. The 1-1 tilt member and the 1-2 tilt member may be bent and formed from the first connecting plate. The 2-1 tilt member and the 2-2 tilt member may be bent and formed from the second connecting plate.

The tilt driving unit may further include a nut member and a screw bar. The nut member may be disposed on the third joint bar. The screw bar may be fastened perpendicularly to the nut member. The screw bar may rotate the first tilt member and the second tilt member to tilt the antenna unit when rotated.

The tilt driving unit may further include a mounting bracket and a manual tilt adjustment member. A first guide hole for guiding the third joint bar up and down when the screw bar rotates may be formed on the side of the mounting bracket. The manual tilt adjustment member may be rotatably disposed on the upper surface of the mounting bracket. The manual tilt adjustment member may be coupled to one end of the screw bar.

A second guide hole may be formed in the first tilt member and the second tilt member. A guide protrusion may be formed on the side of the mounting bracket. The guide protrusion may guide the rotation of the first tilt member and the second tilt member by moving along the second guide hole when the third joint bar moves up and down along the first guide hole.

The tilt driving unit may further include a tilt motor. The tilt motor may be mounted on the upper surface of the mounting bracket. The rotation axis of the tilt motor may be connected to the manual tilt adjustment member to rotate the screw bar.

The plurality of tilt members may be formed in a block shape.

The plurality of joint bars may consist of a first joint bar, a second joint bar, a third joint bar, and a fourth joint bar. The second joint bar may be spaced forward from the first joint bar. The second joint bar may be arranged parallel to the first joint bar. The third joint bar may be spaced upward or downward between the first joint bar and the second joint bar. The third joint bar may be arranged parallel to the first joint bar and the second joint bar. The fourth joint bar may be spaced in the opposite direction to the third joint bar between the first joint bar and the second joint bar. The fourth joint bar may be arranged parallel to the first joint bar, the second joint bar, and the third joint bar.

The plurality of tilt members may consist of a first tilt member, a second tilt member, a third tilt member, and a fourth tilt member. Both ends of the first tilt member may be rotatably coupled to the first joint bar and the third joint bar, respectively. Both ends of the second tilt member may be rotatably coupled to the second joint bar and the third joint bar, respectively. Both ends of the third tilt member may be rotatably coupled to the first joint bar and the fourth joint bar, respectively. Both ends of the fourth tilt member may be rotatably coupled to the second joint bar and the fourth joint bar, respectively.

A first coupling block coupled to the support pole may be protrusively formed on the rear surface of the first tilt member. A second coupling block coupled to the rear surface of the antenna unit may be protrusively formed on the front surface of the second tilt member.

The length between both ends of each of the first tilt member, the second tilt member, the third tilt member, and the fourth tilt member may be formed to be the same length.

The length between both ends of each of the first tilt member and the second tilt member may be formed to be the same first length. The length between both ends of each of the third tilt member and the fourth tilt member may be formed to be the same second length. The first length and the second length may be formed to be different lengths.

A first rotational coupling part and a second rotational coupling part may be protrusively formed on the first tilt member. Both ends of the first rotational coupling part may be rotatably coupled to one end of the first joint bar and one end of the third joint bar, respectively. Both ends of the second rotational coupling part may be rotatably coupled to the other end of the first joint bar and the other end of the third joint bar, respectively. A third rotational coupling part and a fourth rotational coupling part may be protrusively formed on the second tilt member. Both ends of the third rotational coupling part may be rotatably coupled to one end of the second joint bar and one end of the third joint bar, respectively. Both ends of the fourth rotational coupling part may be rotatably coupled to the other end of the second joint bar and the other end of the third joint bar, respectively. A fifth rotational coupling part and a sixth rotational coupling part may be protrusively formed on the third tilt member. Both ends of the fifth rotational coupling part may be rotatably coupled to one end of the first joint bar and one end of the fourth joint bar, respectively. Both ends of the sixth rotational coupling part may be rotatably coupled to the other end of the first joint bar and the other end of the fourth joint bar, respectively. A seventh rotational coupling part and an eighth rotational coupling part may be protrusively formed on the fourth tilt member. Both ends of the seventh rotational coupling part may be rotatably coupled to one end of the second joint bar and one end of the fourth joint bar, respectively. Both ends of the eighth rotational coupling part may be rotatably coupled to the other end of the second joint bar and the other end of the fourth joint bar, respectively.

The tilt driving unit may further include a nut member and a screw bar. The nut member may be disposed on either the third joint bar or the fourth joint bar. The screw bar may be fastened perpendicularly to the nut member. The screw bar may rotate the first tilt member, the second tilt member, the third tilt member, and the fourth tilt member to tilt the antenna unit when rotated.

The one of the aforementioned joint bars may pass through the nut member from side to side. The screw bar may pass through the nut member and the one of the aforementioned joint bars from top to bottom.

The tilt driving unit may further include a tilt motor. The tilt motor may rotate the screw bar. The other of the third joint bar and the fourth joint bar may pass through the tilt motor from side to side.

A support pole mounting unit may be coupled to the support pole. An antenna mounting unit may be coupled to the antenna unit. The rear surface of the third tilt member may be coupled to the support pole mounting unit. The front surface of the fourth tilt member may be coupled to the antenna mounting unit.

The at least one bushing may have a cutout portion formed by cutting one side. At least a portion of the opposite side of the cutout portion of the at least one bushing may be circularly welded to each of the plurality of tilt members.

A coupling part and a reinforcing plate may be formed in the antenna mounting unit. The coupling part may be coupled to the second joint bar. The coupling part may be formed in a hollow pipe shape. The reinforcing plate may be formed in a triangular plate shape welded to the coupling part.

The rear surface of the 1-1 tilt member and the rear surface of the 1-2 tilt member may be connected by a first connecting bar. The front surface of the 2-1 tilt member and the front surface of the 2-2 tilt member may be connected by a second connecting bar. The rear surface of the 3-1 tilt member and the rear surface of the 3-2 tilt member may be connected by a third connecting bar. The front surface of the 4-1 tilt member and the front surface of the 4-2 tilt member may be connected by a fourth connecting bar.

Specific details of other embodiments are included in the detailed description and drawings.

### Advantageous Effects

The antenna device according to the present disclosure has the effect of facilitating the operation of the tilt driving unit by reducing the weight of the tilt driving unit while ensuring sufficient rigidity, because the plurality of joint bars constituting the tilt driving unit for tilting the antenna unit are formed in a hollow pipe shape.

In addition, the antenna device according to the present disclosure has the effect that an operator may manually tilt the antenna unit by rotating a manual tilt adjustment member, and can automatically tilt the antenna unit by the operation of a tilt motor by coupling the rotation axis of the tilt motor to the manual tilt adjustment member.

In addition, the antenna device according to the present disclosure also has the effect of facilitating the operation of the tilt driving unit and reducing operating noise, because at least one bushing is coupled to both ends of each of the plurality of tilt members, and the plurality of joint bars are rotatably coupled to the at least one bushing.

In addition, in the antenna device according to the present invention, since the at least one bushing has a cutout portion formed by cutting one side, and at least a portion of the opposite side of the cutout portion of the at least one bushing is circularly welded to each of the plurality of tilt members, when the plurality of tilt members rotate, the at least one bushing elastically moves around the cutout portion, thereby facilitating the rotational operation of the plurality of tilt members.

In addition, the antenna device according to the present disclosure may be robustly coupled to the support pole against external forces such as wind, because if the vertical length of the antenna unit is relatively long, the antenna unit can be installed on the support pole through the lower link unit and the tilt driving unit, and if the vertical length of the antenna unit is relatively short, the antenna unit can be installed on the support pole only through the tilt driving unit.

In addition, the antenna device according to the present disclosure may tilt the antenna unit with a simple structure, because the tilt driving unit can be directly installed on the support pole and the antenna unit, respectively, without the existing support pole mounting unit installed on the support pole and the existing antenna mounting unit installed on the antenna unit.

The effects of the present disclosure are not limited to those mentioned above, and other unmentioned effects will be clearly understood by those skilled in the art from the description of the claims.

### BRIEF DESCRIPTION OF THE DRAWINGS

FIG. 1 is a side view illustrating an antenna device according to a first embodiment of the present disclosure.

FIG. 2 is a view illustrating a state in which a tilt driving unit shown in FIG. 1 tilts an antenna unit.

FIG. 3 is an enlarged view illustrating the tilt driving unit shown in FIG. 1.

FIG. 4 is a front perspective view of FIG. 3.

FIG. 5 is a rear perspective view of FIG. 3.

FIG. 6 is an exploded perspective view illustrating the fourth joint bar and the 3-1 tilt member shown in FIG. 4.

FIG. 7 is a cross-sectional view of the coupled state of FIG. 6.

FIG. 8 is a perspective view illustrating the nut member, screw bar, and tilt motor shown in FIGS. 4 and 5.

FIG. 9 is a bottom perspective view of FIG. 8.

FIG. 10 is an exploded perspective view illustrating the upper part of FIGS. 8 and 9.

FIG. 11 is a bottom perspective view of FIG. 10.

FIG. 12 is an exploded perspective view illustrating the lower part of FIGS. 8 and 9.

FIG. 13 is a bottom perspective view of FIG. 12.

FIG. 14 is a view illustrating another embodiment of the antenna mounting unit and the support pole mounting unit shown in FIG. 4.

FIG. 15 is a view illustrating a state in which a reinforcing plate is added to the antenna mounting unit shown in FIG. 14.

FIG. 16 is a rear perspective view illustrating the lower link unit shown in FIG. 1.

FIG. 17 is a side view illustrating an antenna device according to a second embodiment of the present disclosure.

FIG. 18 is an enlarged view illustrating the lower link unit and the tilt driving unit shown in FIG. 17.

FIG. 19 is a front perspective view of FIG. 18.

FIG. 20 is a rear perspective view of FIG. 18.

FIG. 21 is a cross-sectional view of the tilt driving unit shown in FIG. 18.

FIG. 22 is a tilt operation diagram of FIG. 21.

FIG. 23 is a view illustrating FIG. 21 with the tilt motor excluded.

FIG. 24 is a perspective view illustrating the tilt driving unit shown in FIG. 17.

FIG. 25 is a rear bottom perspective view of FIG. 24.

FIG. 26 is a view illustrating the internal structure of FIGS. 24 and 25.

FIG. 27 is a bottom perspective view of FIG. 26.

FIG. 28 is a side view illustrating an antenna device according to a third embodiment of the present disclosure.

FIG. 29 is a view illustrating a state in which the tilt driving unit shown in FIG. 28 tilts the antenna unit.

FIG. 30 is an enlarged view illustrating the tilt driving unit shown in FIG. 28.

FIG. 31 is a front perspective view of FIG. 30.

FIG. 32 is a rear bottom perspective view of FIG. 30.

FIG. 33 is a view illustrating a state in which the tilt driving unit of the antenna device according to a fourth embodiment of the present disclosure tilts the antenna unit.

FIG. 34 is a view illustrating a state in which the tilt driving unit of the antenna device according to a fifth embodiment of the present disclosure tilts the antenna unit.

FIG. 35 is a view illustrating an antenna device according to a sixth embodiment of the present disclosure.

FIG. 36 is a view illustrating a state in which the tilt driving unit shown in FIG. 35 tilts the antenna unit so that the front surface of the antenna unit faces downward.

FIG. 37 is a view illustrating a state in which the tilt driving unit shown in FIG. 35 tilts the antenna unit so that the front surface of the antenna unit faces upward.

FIG. 38 is an enlarged view illustrating the tilt driving unit shown in FIG. 35.

FIG. 39 is a front perspective view of FIG. 38.

FIG. 40 is a rear bottom perspective view of FIG. 38.

FIG. 41 is a perspective view illustrating another embodiment of the bushing shown in FIG. 6.

FIG. 42 is a side view of FIG. 41.

FIG. 43 is a view illustrating another embodiment of the tilt driving unit shown in FIG. 36.

FIG. 44 is an exploded view illustrating the fourth snap ring of the fourth joint bar shown in FIG. 43.

FIG. 45 is a side view illustrating an antenna device according to a seventh embodiment of the present disclosure.

FIG. 46 is a front perspective view illustrating the tilt driving unit shown in FIG. 45.

FIG. 47 is a rear perspective view illustrating the tilt driving unit shown in FIG. 45.

FIG. 48 is a rear perspective view illustrating the lower link unit shown in FIG. 45.

### DESCRIPTION OF REFERENCE NUMERALS

100: Support pole, 200: Antenna unit
300: Lower link unit, 400: Tilt driving unit
411: First joint bar, 412: Second joint bar
413: Third joint bar, 413A: Third through-hole
414: Fourth joint bar, 414A: Seventh through-hole
415: Clip through-hole, 417: Snap ring through-hole
421: First tilt member, 421A: 1-1 tilt member
421B: 1-2 tilt member, 421C: First connecting plate
421D: First coupling block, 421E: First rotational coupling part
421F: Second rotational coupling part, 422: Second tilt member
422A: 2-1 tilt member, 422B: 2-2 tilt member
422C: Second connecting plate, 422D: Second coupling block
422E: Third rotational coupling part, 422F: Fourth rotational coupling part
423: Third tilt member, 423A: 3-1 tilt member
423B: 3-2 tilt member, 423E: Fifth rotational coupling part
423F: Sixth rotational coupling part, 424: Fourth tilt member
424A: 4-1 tilt member, 424B: 4-2 tilt member
424E: Seventh rotational coupling part, 424F: Eighth rotational coupling part
425: Bushing, 425A: Cutout portion
427: Second guide hole, 430: Nut member
435: First coupling frame, 435A: First through-hole
435B: Second through-hole, 440: Screw bar
445: Manual tilt adjustment member, 450: Tilt motor
460: Mounting bracket, 465: Second coupling frame
465A: Fourth through-hole, 465B: Fifth through-hole
465C: Sixth through-hole, 466: First guide hole
467: Guide protrusion, 600: Antenna mounting unit
700: Support pole mounting unit, B1, B2, B3: Bolt
C1, C2, C3, C4: Clip, SR1, SR2, SR3, SR4: Snap ring

### BEST MODE FOR CARRYING OUT THE INVENTION

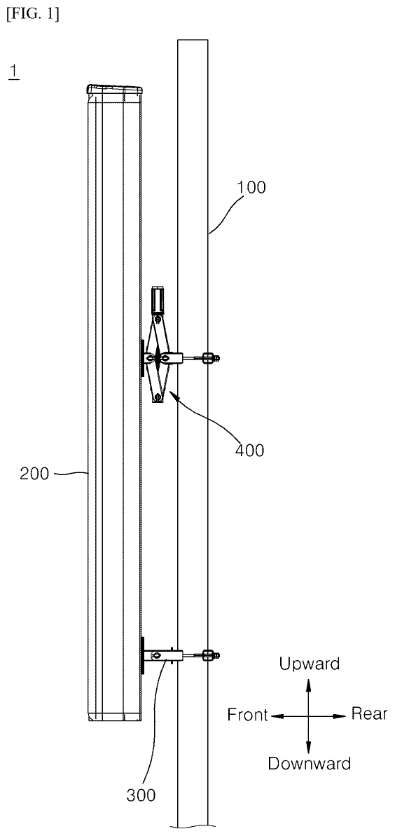

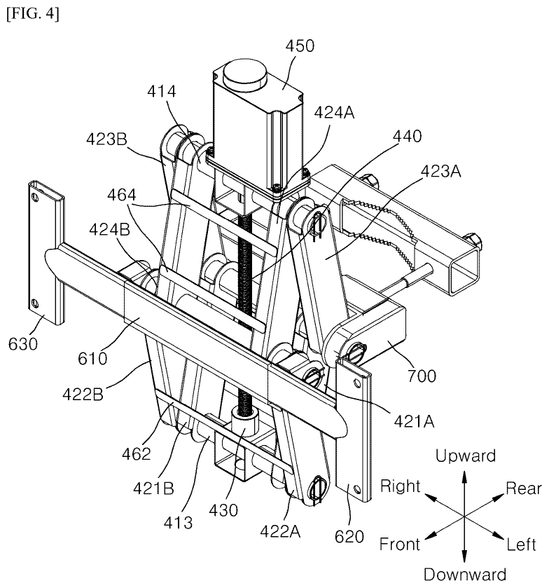

Hereinafter, antenna devices according to embodiments of the present disclosure will be described with reference to the drawings. For components having the same functions in each embodiment, the same names and reference numerals will be used for description. Hereinafter, the terms related to directions such as front, rear, top, bottom, left, and right in the description refer to the same directions as front, rear, top, and bottom shown in FIG. 1, and front, rear, top, bottom, left, and right shown in FIG. 4.

Hereinafter, ‘tilt’ may mean ‘rotation in the up and down direction based on a horizontally arranged rotation center’, and may mean vertical angle adjustment.

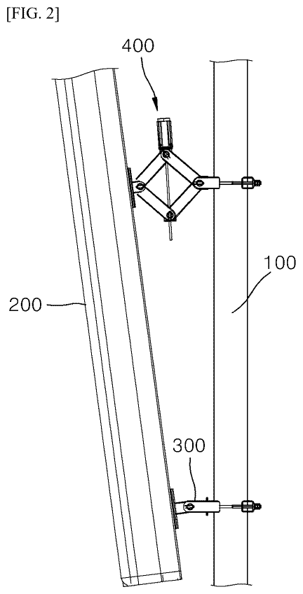

FIG. 1 is a side view illustrating an antenna device according to a first embodiment of the present disclosure, and FIG. 2 is a view illustrating a state in which the tilt driving unit shown in FIG. 1 tilts an antenna unit.

Referring to FIGS. 1 and 2, an antenna device 1 according to a first embodiment of the present disclosure may include a support pole 100, an antenna unit 200, a lower link unit 300, and a tilt driving unit 400.

However, if the vertical length of the antenna unit 200 is shorter than in the first embodiment, the lower link unit 300 may not be provided.

That is, when the vertical length of the antenna unit 200 is relatively long, the lower link unit 300 and the tilt driving unit 400 may be provided, wherein the tilt driving unit 400 couples the upper part of the antenna unit 200 to the support pole 100, and the lower link unit 300 couples the lower part of the antenna unit 200 to the support pole 100, so that the antenna unit 200 may be firmly coupled to the support pole 100 against external forces such as wind.

In addition, when the vertical length of the antenna unit 200 is relatively short, the lower link unit 300 is not provided, and only the tilt driving unit 400 is provided, so that the tilt driving unit 400 may couple the antenna unit 200 to the support pole 100.

The support pole 100 may be formed in a long, vertical bar shape. The support pole 100 may be formed in a bar shape with a circular cross-section. The support pole 100 may support the components of the antenna device according to the embodiment of the present disclosure, except itself.

The antenna unit 200 may be formed in a roughly rectangular box shape. A substrate equipped with antenna elements may be installed inside the antenna unit 200.

The lower link unit 300 may rotatably couple the lower part of the antenna unit 200 to the support pole 100 in the vertical direction. The lower link unit 300 is positioned below the tilt driving unit 400 and may rotatably couple the antenna unit 200 to the support pole in the vertical direction.

The lower link unit 300 may include a first bracket coupled to the support pole 100 and disposed in front of the support pole 100, a second bracket coupled to the rear surface of the antenna unit 200 and disposed behind the antenna unit 200, and a rotation axis that is horizontally long and couples the first bracket and the second bracket rotatably.

The tilt driving unit 400 may couple the antenna unit 200 to the support pole 100. The tilt driving unit 400 may tilt the antenna unit 200. The tilt driving unit 400 may couple the upper part of the antenna unit 200 to the support pole 100. The tilt driving unit 400 may tilt the upper part of the antenna unit 200 by rotating it around the rotation center of the lower link unit 300.

The support pole 100 may be spaced rearward from the antenna unit 200. The antenna unit 200 may be spaced forward from the support pole 100. The lower link unit 300 may be spaced downward from the tilt driving unit 400. The lower link unit 300 may connect between the support pole 100 and the antenna unit 200. The tilt driving unit 400 may be spaced upward from the lower link unit 300. The tilt driving unit 400 may connect between the support pole 100 and the antenna unit 200.

The specific structure of the tilt driving unit 400 of the first embodiment will be described in detail below.

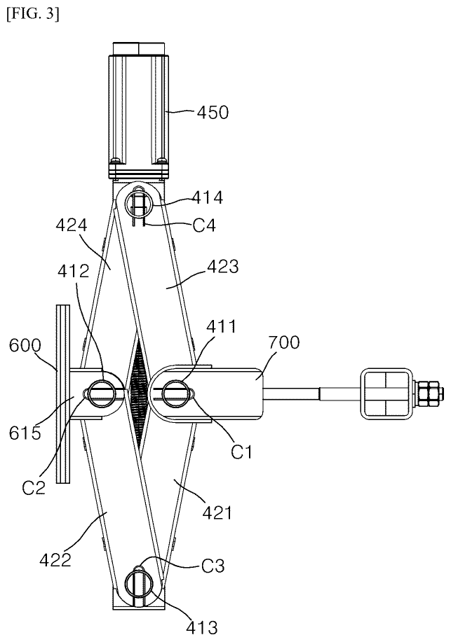

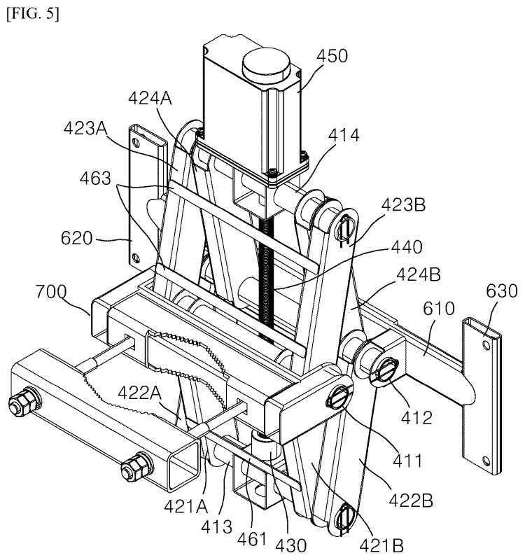

FIG. 3 is an enlarged view illustrating the tilt driving unit shown in FIG. 1, FIG. 4 is a front perspective view of FIG. 3, and FIG. 5 is a rear perspective view of FIG. 3.

Referring to FIGS. 3 to 5, the tilt driving unit 400 may include a plurality of joint bars 411, 412, 413 and 414, a plurality of tilt members 421, 422, 423 and 424 whose both ends are rotatably coupled to the plurality of joint bars 411, 412, 413 and 414, a nut member 430, a screw bar 440, and a tilt motor 450.

The plurality of joint bars 411, 412, 413 and 414 may rotatably couple both ends of each of the plurality of tilt members 421, 422, 423 and 424. The plurality of joint bars 411, 412, 413 and 414 may include a first joint bar 411, a second joint bar 412 spaced forward from the first joint bar 411 and arranged parallel to the first joint bar 411, a third joint bar 413 spaced downward between the first joint bar 411 and the second joint bar 412 and arranged parallel to the first joint bar 411 and the second joint bar 412, and a fourth joint bar 414 spaced upward in the opposite direction to the third joint bar 413 between the first joint bar 411 and the second joint bar 412 and arranged parallel to the first joint bar 411, the second joint bar 412, and the third joint bar 413.

The plurality of tilt members 421, 422, 423 and 424 may tilt the antenna unit 200 when rotated. The plurality of tilt members 421, 422, 423 and 424 may include a first tilt member 421 whose both ends are rotatably coupled to the first joint bar 411 and the third joint bar 413 respectively, a second tilt member 422 whose both ends are rotatably coupled to the second joint bar 412 and the third joint bar 413 respectively, a third tilt member 423 whose both ends are rotatably coupled to the first joint bar 411 and the fourth joint bar 414 respectively, and a fourth tilt member 424 whose both ends are rotatably coupled to the second joint bar 412 and the fourth joint bar 414 respectively.

The nut member 430 may be disposed on the third joint bar 413. However, the nut member 430 may also be disposed on the fourth joint bar 414. That is, the nut member 430 may be disposed on either the third joint bar 413 or the fourth joint bar 414, and the mounting bracket 460 to be described later may be disposed on the other of the third joint bar 413 and the fourth joint bar 414.

The screw bar 440 may be formed to be long in the vertical direction. The screw bar 440 is vertically fastened to the nut member 430 and may rotate the first tilt member 421, the second tilt member 422, the third tilt member 423, and the fourth tilt member 424 to tilt the antenna unit 200 when rotated. The tilt motor 450 may be a driving source that rotates the screw bar 440.

A thread may be formed on the inner circumferential surface of the nut member 430, and a thread that is screwed to the thread formed on the inner circumferential surface of the nut member 430 may be formed on the outer circumferential surface of the screw bar 440.

The thread formed on the inner circumferential surface of the nut member 430 and the thread formed on the outer circumferential surface of the screw bar 440 may be formed as 30-degree (DEG) trapezoidal threads.

When the thread formed on the inner circumferential surface of the nut member 430 and the thread formed on the outer circumferential surface of the screw bar 440 are formed as 30-degree (DEG) trapezoidal threads, the advantages are as follows. First, as a kinematic element, there is no eccentric load in the thrust direction, improving steering capability under high load conditions, which may reduce the load transmitted to the tilt motor 450 and thus prevent overload of the tilt motor 450. Second, it has superior strength compared to general involute gear tooth profiles of similar sizes. Third, it has good engagement for power transmission, enabling self-locking. Fourth, both automatic operation through the operation of the tilt motor 450 and manual operation without the tilt motor 450 are possible. Fifth, it may dispense with an aluminum structure.

Meanwhile, an antenna mounting unit 600 may be coupled to the rear surface of the antenna unit 200. The antenna mounting unit 600 may be coupled to the upper part of the antenna unit 200. The second joint bar 412 may be coupled to the antenna mounting unit 600.

The antenna mounting unit 600 may have a coupling part 615 in the shape of a hollow square pipe protruding rearward towards the support pole 100. The coupling part 615 may be coupled to the second joint bar 412 of the tilt driving unit 400. The coupling part 615 may be formed as a pair of coupling parts 615 spaced apart from each other in the left-right direction, and the pair of coupling parts 615 may be coupled to both ends of the second joint bar 412, respectively.

The antenna mounting unit 600 may include a horizontal bracket 610 formed long in the horizontal direction, and a pair of vertical brackets 620 and 630 formed long in the vertical direction and coupled to both ends of the horizontal bracket 610, respectively.

The pair of coupling parts 615 may be protrusively formed rearward on the rear surface of the horizontal bracket 610, and the pair of vertical brackets 620 and 630 may be fastened to the rear surface of the antenna unit 200 via bolts or screws.

A support pole mounting unit 700 may be coupled to the upper part of the support pole 100. The first joint bar 411 may be coupled to the support pole mounting unit 700. The support pole mounting unit 700 may be coupled to the first joint bar 411 of the tilt driving unit 400.

After the first tilt member 421 and the third tilt member 423 are rotatably coupled to the first joint bar 411, and the support pole mounting unit 700 is coupled to both ends of the first joint bar 411, a first clip C1 may be installed at each of both ends of the first joint bar 411. The first clip C1 may prevent the first joint bar 411 from detaching from the first tilt member 421 and the third tilt member 423.

After the second tilt member 422 and the fourth tilt member 424 are rotatably coupled to the second joint bar 412, and the coupling part 61) of the antenna mounting unit 600 is coupled to both ends of the second joint bar 412, a second clip C2 may be installed at each of both ends of the second joint bar 412. The second clip C2 may prevent the second joint bar 412 from detaching from the second tilt member 422 and the fourth tilt member 424.

After the first tilt member 421 and the second tilt member 422 are rotatably coupled to the third joint bar 413, a third clip C3 may be installed at each of both ends of the third joint bar 413. The third clip C3 may prevent the third joint bar 413 from detaching from the first tilt member 421 and the second tilt member 422.

After the third tilt member 423 and the fourth tilt member 424 are rotatably coupled to the fourth joint bar 414, a fourth clip C4 may be installed at each of both ends of the fourth joint bar 414. The fourth clip C4 may prevent the fourth joint bar 414 from detaching from the third tilt member 423 and the fourth tilt member 424.

The first tilt member 421 may include a 1-1 tilt member 421A whose both ends are rotatably coupled to one end of the first joint bar 411 and one end of the third joint bar 413 respectively, and a 1-2 tilt member 421B whose both ends are rotatably coupled to the other end of the first joint bar 411 and the other end of the third joint bar 413 respectively.

The second tilt member 422 may include a 2-1 tilt member 422A whose both ends are rotatably coupled to one end of the second joint bar 412 and one end of the third joint bar 413 respectively, and a 2-2 tilt member 422B whose both ends are rotatably coupled to the other end of the second joint bar 412 and the other end of the third joint bar 413 respectively.

The third tilt member 423 may include a 3-1 tilt member 423A whose both ends are rotatably coupled to one end of the first joint bar 411 and one end of the fourth joint bar 414 respectively, and a 3-2 tilt member 423B whose both ends are rotatably coupled to the other end of the first joint bar 411 and the other end of the fourth joint bar 414 respectively.

The fourth tilt member 424 may include a 4-1 tilt member 424A whose both ends are rotatably coupled to one end of the second joint bar 412 and one end of the fourth joint bar 414 respectively, and a 4-2 tilt member 424B whose both ends are rotatably coupled to the other end of the second joint bar 412 and the other end of the fourth joint bar 414 respectively.

The rear surface of the 1-1 tilt member 421A and the rear surface of the 1-2 tilt member 421B may be connected by a plate-shaped first connecting bar 461. The first connecting bar 461 may be provided as a pair of first connecting bars 461 spaced apart from each other in the vertical direction.

The front surface of the 2-1 tilt member 422A and the front surface of the 2-2 tilt member 422B may be connected by a plate-shaped second connecting bar 462. The second connecting bar 462 may be provided as a pair of second connecting bars 462 spaced apart from each other in the vertical direction.

The rear surface of the 3-1 tilt member 423A and the rear surface of the 3-2 tilt member 423B may be connected by a plate-shaped third connecting bar 463. The third connecting bar 463 may be provided as a pair of third connecting bars 463 spaced apart from each other in the vertical direction.

The front surface of the 4-1 tilt member 424A and the front surface of the 4-2 tilt member 424B may be connected by a plate-shaped fourth connecting bar 464. The fourth connecting bar 464 may be provided as a pair of fourth connecting bars 464 spaced apart from each other in the vertical direction.

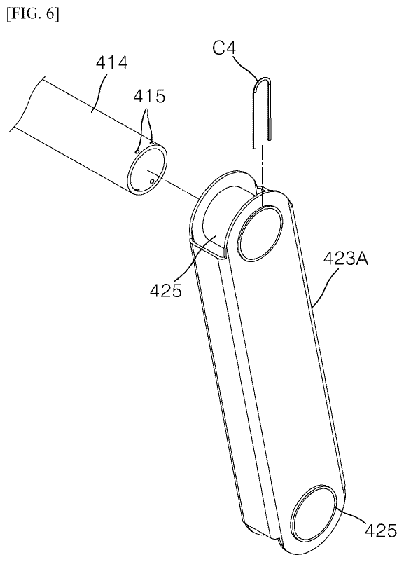

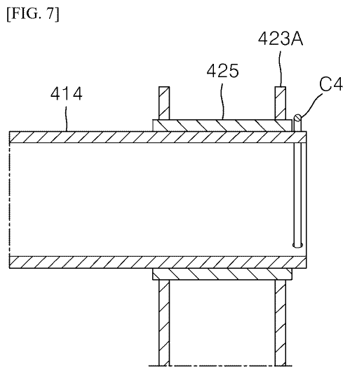

FIG. 6 is an exploded perspective view illustrating the fourth joint bar and the 3-1 tilt member shown in FIG. 4, and FIG. 7 is a cross-sectional view of the coupled state of FIG. 6.

Referring to FIGS. 6 and 7, the fourth joint bar 414 may be formed in a hollow pipe shape. Specifically, the fourth joint bar 414 may be formed in a hollow circular pipe shape.

Similarly, the fourth joint bar 414, the first joint bar 411, the second joint bar 412, and the third joint bar 413 may also be formed in a hollow pipe shape. That is, the plurality of joint bars 411, 412, 413 and 414 may be formed in a hollow pipe shape, thereby reducing the weight of the tilt driving unit 400 and facilitating the tilt operation of the tilt driving unit 400.

Furthermore, the 3-1 tilt member 423A may be formed in a hollow pipe shape. Specifically, the 3-1 tilt member 423A may be formed in a hollow square pipe shape.

Similarly, the 3-1 tilt member 423A, the 1-1 tilt member 421A, the 1-2 tilt member 421B, the 2-1 tilt member 422A, the 2-2 tilt member 422B, the 3-2 tilt member 423B, the 4-1 tilt member 424A, and the 4-2 tilt member 424B may also be formed in a hollow pipe shape. That is, the plurality of tilt members 421, 422, 423 and 424 may be formed in a hollow pipe shape, thereby reducing the weight of the tilt driving unit 400 and facilitating the tilt operation of the tilt driving unit 400.

In addition, a bushing 425 may be coupled to both ends of the 3-1 tilt member 423A, respectively. Similarly, the 3-1 tilt member 423A, a bushing 425 may also be coupled to both ends of each of the 1-1 tilt member 421A, the 1-2 tilt member 421B, the 2-1 tilt member 422A, the 2-2 tilt member 422B, the 3-2 tilt member 423B, the 4-1 tilt member 424A, and the 4-2 tilt member 424B. That is, a bushing 425 may be coupled to both ends of each of the plurality of tilt members 421, 422, 423 and 424, and the plurality of joint bars 411, 412, 413 and 414 may be rotatably coupled to the bushing 425 respectively. The bushing 425 may be coupled to each of the plurality of tilt members 421, 422, 423 and 424 by being welded around its circumference. The bushing 425 may facilitate the rotational operation of the plurality of tilt members 421, 422, 423 and 424 when they rotate, and also reduce rotational noise.

Although the drawings exemplify a single bushing 425 coupled to each of the both ends of the plurality of tilt members 421, 422, 423 and 424, a plurality of bushings 425 may also be coupled to each of the both ends of the plurality of tilt members 421, 422, 423 and 424. That is, at least one bushing 425 may be coupled to each of the both ends of the plurality of tilt members 421, 422, 423 and 424, and the plurality of joint bars 411, 412, 413 and 414 may be rotatably coupled to the at least one bushing 425 respectively.

When a single bushing 425 is coupled to each of the both ends of the plurality of tilt members 421, 422, 423 and 424, the tolerance of the space where the bushing 425 is installed is relatively small, so the fluidity of the bushing 425 is relatively reduced, and thus the rotational movement of the plurality of tilt members 421, 422, 423 and 424 may not be relatively smooth. When a plurality of bushings 425 are coupled to each of the both ends of the plurality of tilt members 421, 422, 423 and 424, the tolerance of the space where the plurality of bushings 425 are installed is relatively large, so the fluidity of the plurality of bushings 425 is relatively improved, and thus the rotational movement of the plurality of tilt members 421, 422, 423 and 424 may be relatively smooth.

A plurality of bushings 425 may be installed on each of the both ends of the plurality of tilt members 421, 422, 423 and 424 in the longitudinal direction of each of the plurality of joint bars 411, 412, 413 and 414, or a plurality of bushings 425 may be installed by inserting one bushing 425 inside another bushing 425.

In addition, a clip through-hole 415 may be formed at the end of the fourth joint bar 414. The clip through-hole 415 may be formed at each of both ends of the fourth joint bar 414. The fourth clip C4 may pass through the clip through-hole 415 to couple the fourth joint bar 414 to the 3-1 tilt member 423A.

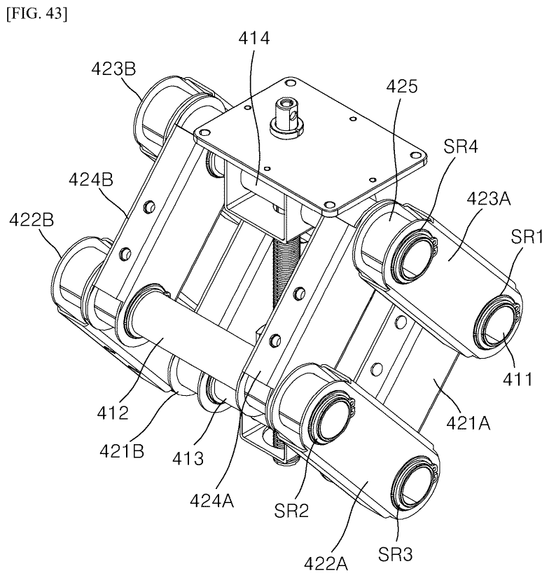

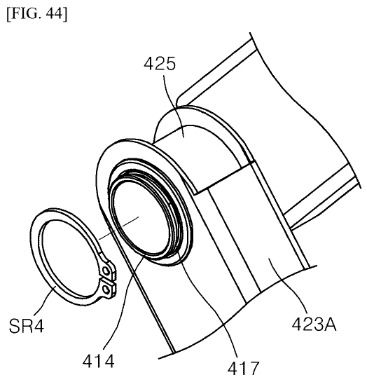

Similarly, the fourth joint bar 414, a clip through-hole 415 may also be formed at both ends of each of the first joint bar 411, the second joint bar 412, and the third joint bar 413. That is, a clip through-hole 415 may be formed at both ends of the plurality of joint bars 411, 412, 413 and 414, and a plurality of clips C1, C2, C3 and C4 (refer to FIG. 3) may each pass through the clip through-hole 415 formed at both ends of the plurality of joint bars 411, 412, 413 and 414 to couple the plurality of joint bars 411, 412, 413 and 414 to the plurality of tilt members 421, 422, 423 and 424 respectively. Here, the plurality of clips C1, C2, C3 and C4 may be used as a plurality of fixing fasteners together with a plurality of snap rings SR1, SR2, SR3 and SR4 (refer to FIGS. 43 and 44). That is, the plurality of fixing fasteners may have the function of coupling both ends of the plurality of joint bars 411, 412, 413 and 414 to the plurality of tilt members 421, 422, 423 and 424 respectively.

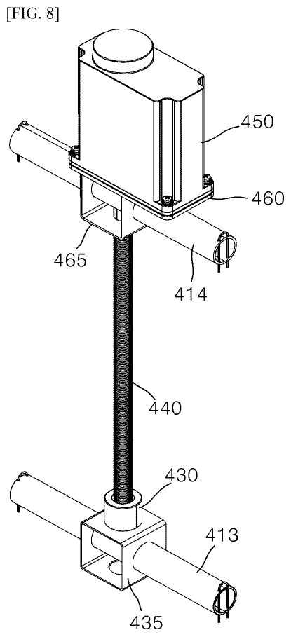

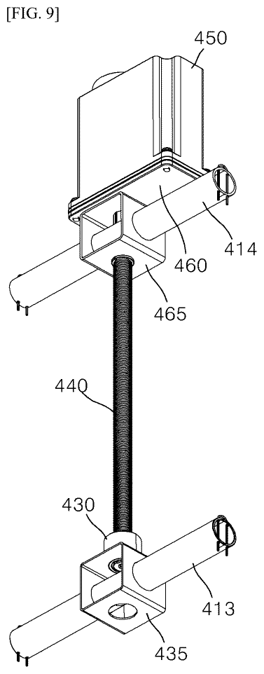

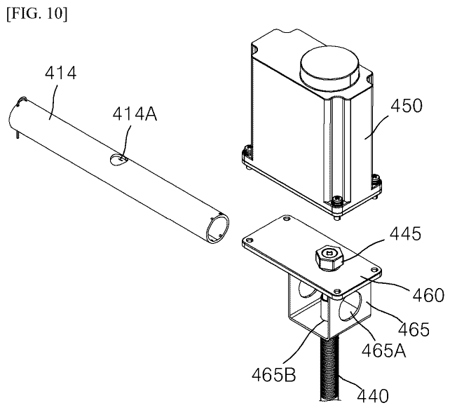

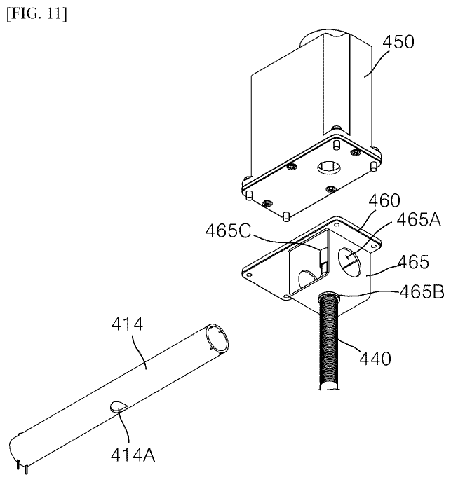

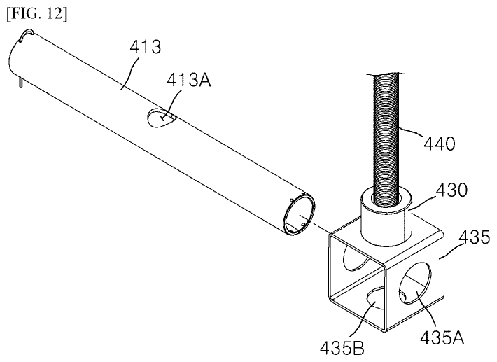

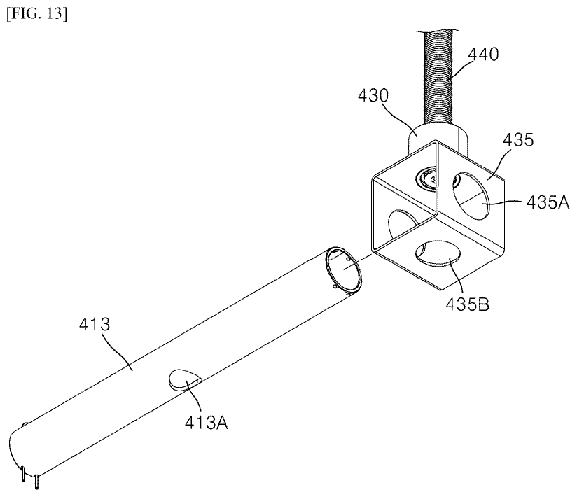

FIG. 8 is a perspective view illustrating the nut member, screw bar, and tilt motor shown in FIGS. 4 and 5, FIG. 9 is a bottom perspective view of FIG. 8, FIG. 10 is an exploded perspective view illustrating the upper part of FIGS. 8 and 9, FIG. 11 is a bottom perspective view of FIG. 10, FIG. 12 is an exploded perspective view illustrating the lower part of FIGS. 8 and 9, and FIG. 13 is a bottom perspective view of FIG. 12.

Referring to FIGS. 8 to 13, a first coupling frame 435 in the shape of a hollow pipe may be placed in the nut member 430. The first coupling frame 435 may be coupled to the lower side of the nut member 430. The first coupling frame 435 may be formed in a hollow square pipe shape, but it may be formed in various pipe shapes including a circular shape if it is a hollow structure.

A first through-hole 435A, through which the third joint bar 413 passes, may be formed on each side of the first coupling frame 435. A second through-hole 435B, through which the screw bar 440 passes, may be formed on the upper and lower sides of the first coupling frame 435. A third through-hole 413A, through which the screw bar 440 passes, may be formed in the third joint bar 413. The third through-hole 413A may be formed in the middle of the left-right length of the third joint bar 413.

The tilt driving unit 400 may further include a mounting bracket 460 and a manual tilt adjustment member 445. The mounting bracket 460 may be disposed on the fourth joint bar 414. The mounting bracket 460 may be formed as a plate with horizontal upper and lower surfaces. The manual tilt adjustment member 445 may be rotatably disposed on the mounting bracket 460.

The manual tilt adjustment member 445 may be coupled to the upper end of the screw bar 440. An operator can manually tilt the antenna unit 200 by rotating the manual tilt adjustment member 445 using a tool such as a spanner, thereby rotating the screw bar 440. In this case, the tilt motor 450 may not be provided. If the tilt motor 450 is provided, the rotation axis of the tilt motor 450 may be coupled to the manual tilt adjustment member 445.

A second coupling frame 465 in the shape of a hollow pipe may be placed in the mounting bracket 460. The second coupling frame 465 may be coupled to the lower side of the mounting bracket 460. The second coupling frame 465 may be formed in a hollow square pipe shape, but it may be formed in various pipe shapes including a circular shape if it is a hollow structure.

A fourth through-hole 465A, through which the fourth joint bar 414 passes, may be formed on each side of the second coupling frame 465. A fifth through-hole 465B, through which the screw bar 440 passes, may be formed on the lower side of the second coupling frame 465. A sixth through-hole 465C, through which the manual tilt adjustment member 445 passes, may be formed on the upper side of the second coupling frame 465. The upper end of the screw bar 440 and the lower end of the manual tilt adjustment member 445 may be coupled to each other via a coupler in the internal space of the second coupling frame 465. A seventh through-hole 414A, through which the coupling part of the screw bar 440 and the manual tilt adjustment member 445 passes, may be formed in the fourth joint bar 414. The seventh through-hole 414A may be formed in the middle of the left-right length of the fourth joint bar 414.

The tilt motor 450 may be mounted on the mounting bracket 460. The tilt motor 450 may be mounted on the upper surface of the mounting bracket 460. When the tilt motor 450 is mounted on the mounting bracket 460, the rotation axis of the tilt motor 450 may be connected to the manual tilt adjustment member 445 to rotate the screw bar 440.

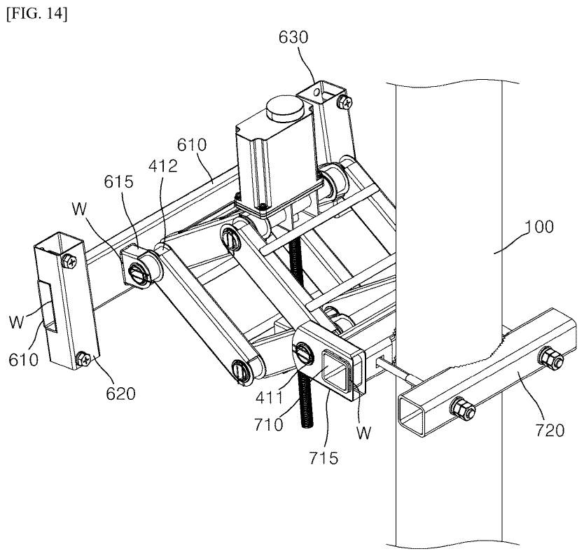

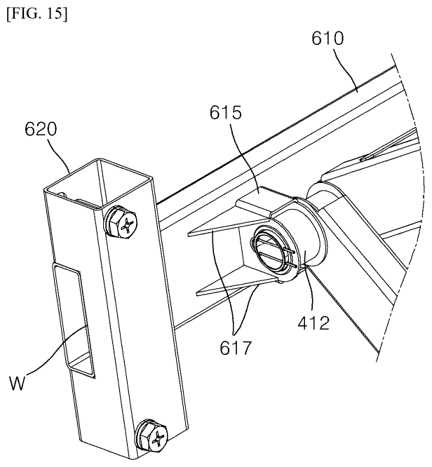

FIG. 14 is a view illustrating another embodiment of the antenna mounting unit and the support pole mounting unit shown in FIG. 4, and FIG. 15 is a view illustrating a state in which a reinforcing plate is added to the antenna mounting unit shown in FIG. 14.

Referring to FIGS. 14 and 15, the support pole mounting unit 700 may include a front horizontal bracket 710 and a rear horizontal bracket 720. The front horizontal bracket 710 and the rear horizontal bracket 720 may be horizontally disposed. The front horizontal bracket 710 and the rear horizontal bracket 720 may be disposed at the same height. The front horizontal bracket 710 and the rear horizontal bracket 720 may be connected by a pair of long bolts. The pair of long bolts may each be fastened with a nut to firmly fix a concave part formed on the rear surface of the front horizontal bracket 710 to the front side of the support pole 100, and a concave part formed on the front surface of the rear horizontal bracket 720 to the rear side of the support pole 100.

The front horizontal bracket 710 may have a coupling part 715 in the shape of a hollow square pipe protrusively installed forward. The coupling part 715 may be provided as a pair of coupling parts 715 spaced apart from each other in the left-right direction. Both ends of the first joint bar 411 may be coupled to the pair of coupling parts 715 respectively.

An insertion hole passing through from left to right may be formed in each of the pair of coupling parts 715, and after both ends of the front horizontal bracket 710 are inserted into the insertion holes formed in each of the pair of coupling parts 715, the edges may be welded W.

Furthermore, an insertion hole passing through from left to right may be formed in the front surface of each of the pair of vertical brackets 620 and 630 of the antenna mounting unit 600, and after both ends of the horizontal bracket 610 are inserted into the insertion holes formed in each of the pair of vertical brackets 620 and 630, the edges may be welded W.

In addition, a pair of insertion holes passing through front to rear may be formed in the horizontal bracket 610 of the antenna mounting unit 600, and after the pair of coupling parts 615 are inserted into the pair of insertion holes formed in the horizontal bracket 610, respectively, the edges may be welded W.

In addition, a pair of reinforcing plates 617 may be fastened to the rear surface of the horizontal bracket 610 of the antenna mounting unit 600 and to one side of each of the pair of coupling parts 615. Each of the pair of reinforcing plates 617 may be formed in a triangular plate shape, and one side may be welded to the rear surface of the horizontal bracket 610, and the other side adjacent to the one side may be welded to the side of the coupling part 615.

Through the above-described insertion and welding W structure of the front horizontal bracket 710 and the pair of coupling parts 715, the insertion and welding W structure of the horizontal bracket 610 and the pair of vertical brackets 620 and 630, the insertion and welding W structure of the horizontal bracket 610 and the pair of coupling parts 615, and the reinforcing plate 617 coupling structure of the horizontal bracket 610 and the pair of coupling parts 615, sufficient rigidity may be secured to firmly support the antenna unit 200 on the support pole 100.

In addition, the antenna mounting unit 600 and the support pole mounting unit 700 may be formed by coupling hollow square pipe-shaped brackets. Through this, the weight of the antenna mounting unit 600 and the support pole mounting unit 700 may be reduced.

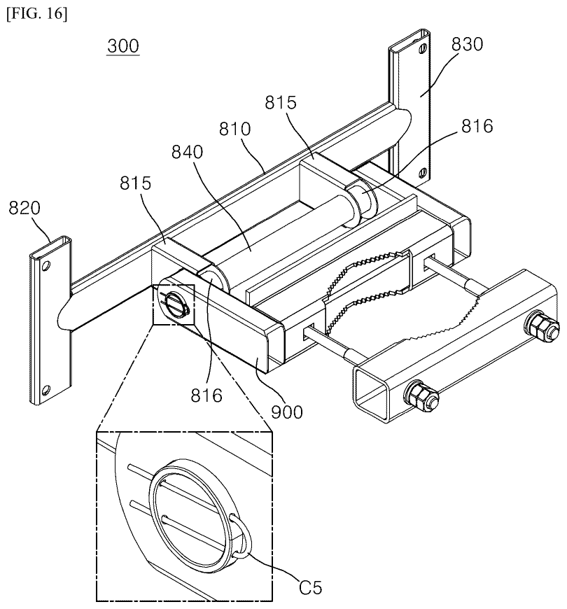

FIG. 16 is a rear perspective view illustrating the lower link unit shown in FIG. 1.

Referring to FIG. 16, the lower link unit 300 may include a horizontal bracket 810 formed long in the horizontal direction, a pair of vertical brackets 820 and 830 formed long in the vertical direction and coupled to both ends of the horizontal bracket 810 respectively, and a fifth joint bar 840.

A pair of coupling parts 815 may be protrusively formed rearward on the rear surface of the horizontal bracket 810, and the pair of vertical brackets 820 and 830 may be fastened to the rear surface of the antenna unit 200 via bolts or screws.

A support pole mounting unit 900 may be coupled to the lower part of the support pole 100. The fifth joint bar 840 may be coupled to the support pole mounting unit 900. The pair of coupling parts 815 formed on the horizontal bracket 810 may be rotatably coupled to the fifth joint bar 840 in the vertical direction. The pair of coupling parts 815 may rotate around the fifth joint bar 840 as the rotation center.

A bushing 816 may be coupled to each of the pair of coupling parts 815. The bushing 816 may be coupled to each of the pair of coupling parts 815 in the same structure as the bushing 425 previously described, which is coupled to both ends of each of the plurality of tilt members 421, 422, 423 and 424. The bushing 816 may be coupled to each of the pair of coupling parts 815 by being welded around its circumference. The bushing 816 may facilitate the rotational operation of the pair of coupling parts 815 when they rotate, and also reduce rotational noise.

Although the drawings exemplify a single bushing 816 coupled to each of the pair of coupling parts 815, a plurality of bushings 816 may also be coupled to each of the pair of coupling parts 815. That is, at least one bushing 816 may be coupled to each of the pair of coupling parts 815, and the fifth joint bar 840 may be rotatably coupled to the at least one bushing 816.

When a single bushing 816 is coupled to each of the pair of coupling parts 815, the tolerance of the space where the bushing 816 is installed is relatively small, so the fluidity of the bushing 816 is relatively reduced, and thus the rotational movement of the pair of coupling parts 815 may not be relatively smooth. When a plurality of bushings 816 are coupled to each of the pair of coupling parts 815, the tolerance of the space where the plurality of bushings 816 are installed is relatively large, so the fluidity of the plurality of bushings 816 is relatively improved, and thus the rotational movement of the pair of coupling parts 815 may be relatively smooth.

A plurality of bushings 816 may be installed on each of the pair of coupling parts 816 in the longitudinal direction of the fifth joint bar 840, or a plurality of bushings 816 may be installed by inserting one bushing 816 inside another bushing 816.

Meanwhile, after the support pole mounting unit 900 is coupled to both ends of the fifth joint bar 840, a fifth clip C5 may be installed at each of both ends of the fifth joint bar 840. The fifth clip C5 may be installed at both ends of the fifth joint bar 840 in the same structure as the plurality of clips C1, C2, C3 and C4 previously described, which are installed at both ends of the plurality of joint bars 411, 412, 413 and 414. The fifth clip C5 may prevent the fifth joint bar 840 from detaching from the pair of coupling parts 815 and the support pole mounting unit 900.

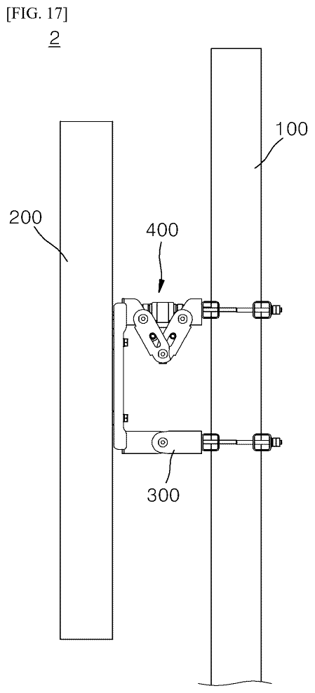

FIG. 17 is a side view illustrating an antenna device according to a second embodiment of the present disclosure.

Referring to FIG. 17, the tilt driving unit 400 of the antenna device 2 according to the second embodiment of the present disclosure may be formed with a different structure from the tilt driving unit 400 of the antenna device 1 according to the first embodiment described above.

The specific structure of the tilt driving unit 400 of the antenna device 2 according to the second embodiment of the present disclosure will be described in detail below. However, for components of the tilt driving unit 400 of the antenna device 2 according to the second embodiment of the present disclosure that have the same function as those of the tilt driving unit 400 of the antenna device 1 according to the first embodiment described above, the same reference numerals will be assigned, and their detailed description will be omitted, with only the differences explained.

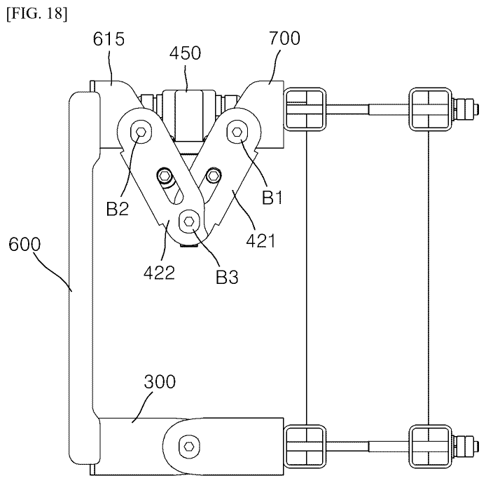

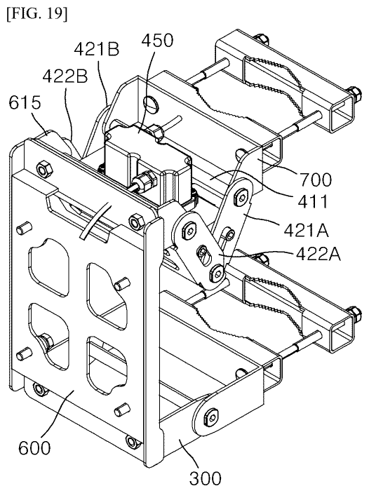

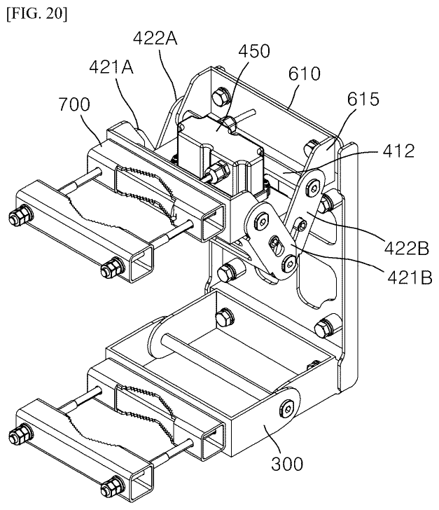

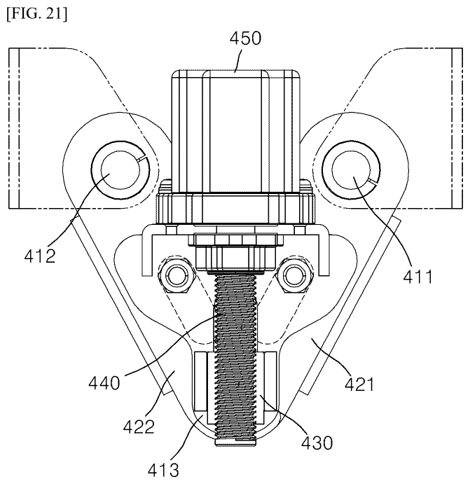

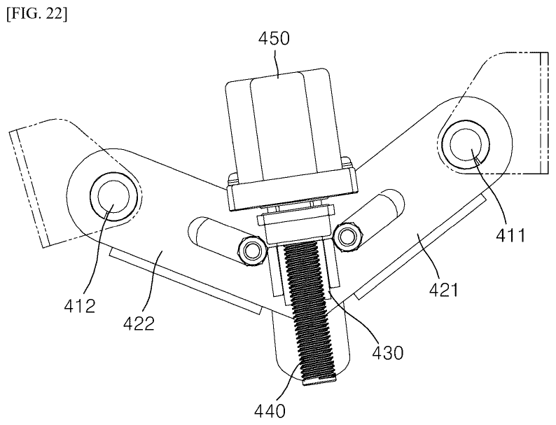

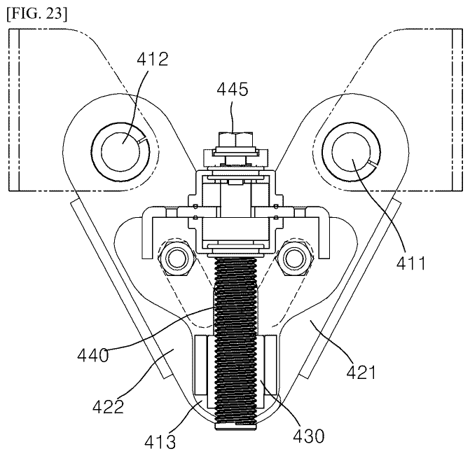

FIG. 18 is an enlarged view illustrating the lower link unit and the tilt driving unit shown in FIG. 17, FIG. 19 is a front perspective view of FIG. 18, FIG. 20 is a rear perspective view of FIG. 18, FIG. 21 is a cross-sectional view of the tilt driving unit shown in FIG. 18, FIG. 22 is a tilt operation diagram of FIG. 21, and FIG. 23 is a view illustrating FIG. 21 with the tilt motor excluded.

Referring to FIGS. 18 to 23, while the tilt driving unit 400 of the antenna device 1 according to the first embodiment described above included four joint bars 411, 412, 413 and 414 and four tilt members 421, 422, 423 and 424, the tilt driving unit 400 of the antenna device 2 according to the second embodiment of the present disclosure may include three joint bars 411, 412 and 413 and two tilt members 421 and 422.

That is, the tilt driving unit 400 of the antenna device 2 according to the second embodiment of the present disclosure may include a first joint bar 411, a second joint bar 412 spaced forward from the first joint bar 411 and arranged parallel to the first joint bar 411, and a third joint bar 413 spaced downward between the first joint bar 411 and the second joint bar 412 and arranged parallel to the first joint bar 411 and the second joint bar 412. However, the third joint bar 413 may also be spaced upward between the first joint bar 411 and the second joint bar 412 and arranged parallel to the first joint bar 411 and the second joint bar 412.

In addition, the tilt driving unit 400 of the antenna device 2 according to the second embodiment of the present disclosure may include a first tilt member 421 whose both ends are rotatably coupled to the first joint bar 411 and the third joint bar 413 respectively, and a second tilt member 422 whose both ends are rotatably coupled to the second joint bar 412 and the third joint bar 413 respectively.

In addition, while the plurality of tilt members 421, 422, 423 and 424 in the tilt driving unit 400 of the antenna device 1 according to the first embodiment described above were formed in a hollow pipe shape, the plurality of tilt members 421 and 422 in the tilt driving unit 400 of the antenna device 2 according to the second embodiment of the present disclosure may be formed in a plate shape.

In addition, while a plurality of clips C1, C2, C3 and C4 were fastened to both ends of each of the plurality of joint bars 411, 412, 413 and 414 to couple the plurality of joint bars 411, 412, 413 and 414 to the plurality of tilt members 421, 422, 423 and 424 respectively in the tilt driving unit 400 of the antenna device 1 according to the first embodiment described above, the tilt driving unit 400 of the antenna device 2 according to the second embodiment of the present disclosure may couple the plurality of joint bars 411, 412 and 413 to the plurality of tilt members 421 and 422 respectively by fastening a plurality of bolts B1, B2 and B3 to both ends of each of the plurality of joint bars 411, 412 and 413.

In addition, while the tilt driving unit 400 of the antenna device 1 according to the first embodiment described above was separated from the lower link unit 300, the front end of the tilt driving unit 400 of the antenna device 2 according to the second embodiment of the present disclosure may be connected to the front end of the lower link unit 300 through the antenna mounting unit 600.

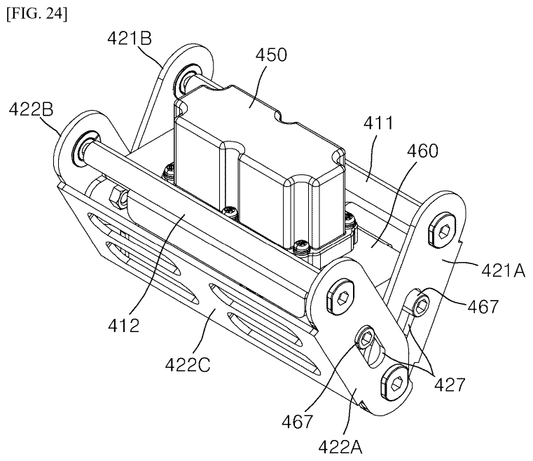

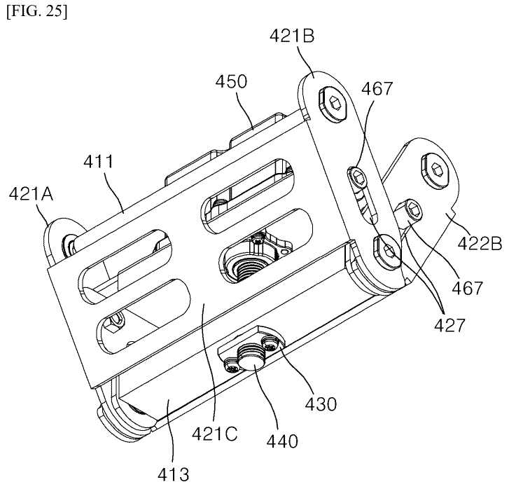

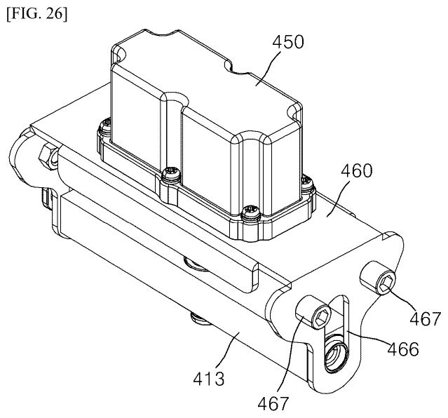

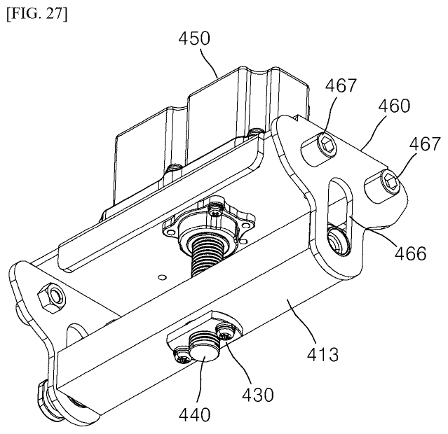

FIG. 24 is a perspective view illustrating the tilt driving unit shown in FIG. 17, FIG. 25 is a rear bottom perspective view of FIG. 24, FIG. 26 is a view illustrating the internal structure of FIGS. 24 and 25, and FIG. 27 is a bottom perspective view of FIG. 26.

Referring to FIGS. 23 to 27, the tilt driving unit 400 of the antenna device 2 according to the second embodiment of the present disclosure may further include a first connecting plate 421C and a second connecting plate 422C compared to the tilt driving unit 400 of the antenna device 1 according to the first embodiment described above.

The first connecting plate 421C may connect the 1-1 tilt member 421A and the 1-2 tilt member 421B, and the second connecting plate 422C may connect the 2-1 tilt member 422A and the 2-2 tilt member 422B.

A plurality of holes may be formed in each of the first connecting plate 421C and the second connecting plate 422C to reduce weight.

The 1-1 tilt member 421A and the 1-2 tilt member 421B may be bent and formed from the first connecting plate 421C, and the 2-1 tilt member 422A and the 2-2 tilt member 422B may be bent and formed from the second connecting plate 422C.

The 1-1 tilt member 421A may be formed by bending rearward from the left end of the first connecting plate 421C, and the 2-2 tilt member 421B may be formed by bending rearward from the right end of the first connecting plate 421C. The 2-1 tilt member 422A may be formed by bending forward from the left end of the second connecting plate 422C, and the 2-2 tilt member 422B may be formed by bending forward from the right end of the second connecting plate 422C.

The nut member 430 may be partially inserted and installed in a through-hole formed vertically in the center of the third joint bar 413 in the left-right direction. The screw bar 440 may rotate the first tilt member 421 and the second tilt member 422 to tilt the antenna unit 200 when rotated.

The mounting bracket 460 may include an upper plate part and a side plate part. Here, the upper plate part may be horizontally disposed to form the upper surface of the mounting bracket 460, and the side plate part may be bent downward from both left and right ends of the upper plate part, respectively, to form the side surfaces of the mounting bracket 460.

The manual tilt adjustment member 445 may be rotatably disposed on the upper surface of the mounting bracket 460. The tilt motor 450 may be mounted on the upper surface of the mounting bracket 460.

A first guide hole 466 may be formed on the side of the mounting bracket 460. The first guide hole 466 may be formed on both side surfaces of the mounting bracket 460. Both ends of the third joint bar 413 may be inserted into the first guide holes 466 formed on both side surfaces of the mounting bracket 460, respectively. The first guide hole 466 may be formed long in the vertical direction and can guide the third joint bar 413 up and down when the screw bar 440 rotates.

A second guide hole 427 may be formed in the first tilt member 421 and the second tilt member 422. It may be formed long in the longitudinal direction of each of the first tilt member 421 and the second tilt member 422. The second guide hole 427 may be formed in the 1-1 tilt member 421A, the 1-2 tilt member 421B, the 2-1 tilt member 422A, and the 2-2 tilt member 422B, respectively.

A guide protrusion 467 may be formed on the side of the mounting bracket 460. The guide protrusion 467 may guide the rotation of the first tilt member 421 and the second tilt member 422 by moving along the second guide hole 427 when the third joint bar 413 moves up and down along the first guide hole 466.

At least the upper part of the guide protrusion 467 may be disposed above the first guide hole 466. The guide protrusion 467 may be formed as a pair on both sides of the mounting bracket 460. Among the pair of guide protrusions 467 formed on the left side of the mounting bracket 460, the guide protrusion 467 disposed at the rear may pass through the second guide hole 427 formed in the 1-1 tilt member 421A, and the guide protrusion 467 disposed at the front can pass through the second guide hole 427 formed in the 2-1 tilt member 422A. Among the pair of guide protrusions 467 formed on the right side of the mounting bracket 460, the guide protrusion 467 disposed at the rear may pass through the second guide hole 427 formed in the 1-2 tilt member 421B, and the guide protrusion 467 disposed at the front may pass through the second guide hole 427 formed in the 2-2 tilt member 422B.

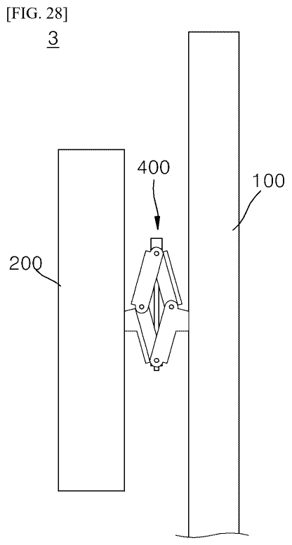

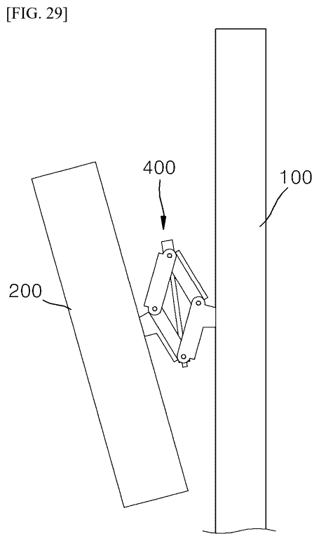

FIG. 28 is a side view illustrating an antenna device according to a third embodiment of the present invention, and FIG. 29 is a view illustrating a state in which the tilt driving unit shown in FIG. 28 tilts the antenna unit.

Referring to FIGS. 28 and 29, the tilt driving unit 400 of the antenna device 3 according to the third embodiment of the present disclosure may be formed with a different structure from the tilt driving unit 400 of the antenna device 1 according to the first embodiment described above.

The specific structure of the tilt driving unit 400 of the antenna device 3 according to the third embodiment of the present disclosure will be described in detail below. However, for components of the tilt driving unit 400 of the antenna device 3 according to the third embodiment of the present disclosure that have the same function as those of the tilt driving unit 400 of the antenna device 1 according to the first embodiment described above, the same reference numerals will be assigned, and their detailed description will be omitted, with only the differences explained.

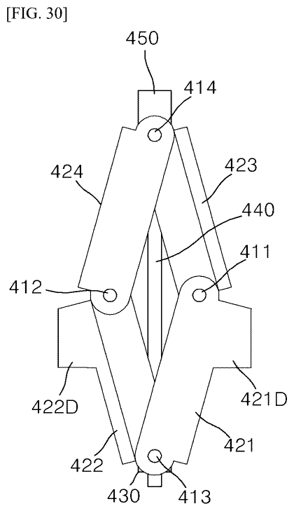

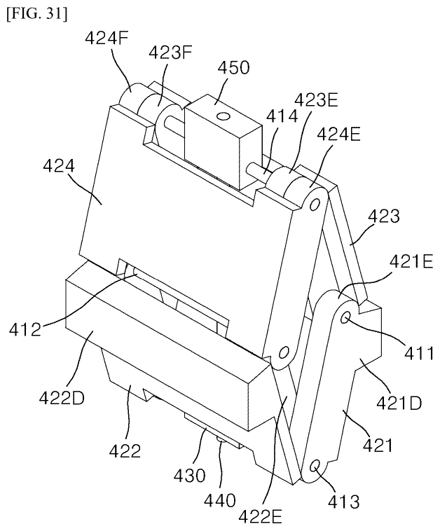

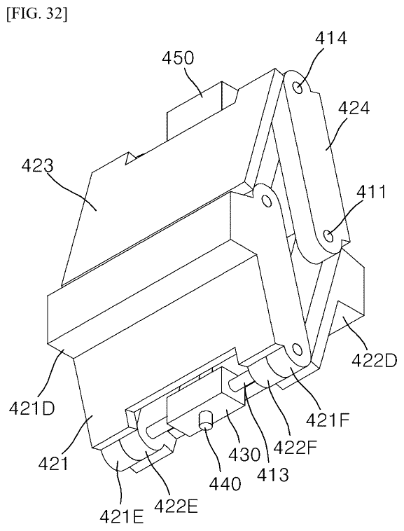

FIG. 30 is an enlarged view illustrating the tilt driving unit shown in FIG. 28, FIG. 31 is a front perspective view of FIG. 30, and FIG. 32 is a rear bottom perspective view of FIG. 30. Here, the plurality of joint bars 411, 412, 413 and 414 are shown as being shaft-shaped, but this is a schematic representation of the plurality of joint bars 411, 412, 413 and 414, and in practice, the plurality of joint bars 411, 412, 413 and 414 may be formed in a hollow pipe shape, similar to the plurality of joint bars 411, 412, 413 and 414 of the tilt driving unit 400 of the antenna device 1 according to the first embodiment described above.

Referring to FIGS. 30 to 32, while the plurality of tilt members 421, 422, 423 and 424 in the tilt driving unit 400 of the antenna device 1 according to the first embodiment described above were formed in a hollow pipe shape, the plurality of tilt members 421, 422, 423 and 424 in the tilt driving unit 400 of the antenna device 3 according to the third embodiment of the present disclosure may be formed in a block shape. Therefore, the tilt driving unit 400 of the antenna device 3 according to the third embodiment of the present disclosure may have a simpler structure compared to the tilt driving unit 400 of the antenna device 1 according to the first embodiment described above.

In addition, while in the tilt driving unit 400 of the antenna device 1 according to the first embodiment described above, the first joint bar 411 was coupled to the support pole mounting unit 700 and the second joint bar 422 was coupled to the antenna mounting unit 600, the antenna device 3 according to the third embodiment of the present disclosure does not include the support pole mounting unit 700 and the antenna mounting unit 600 of the first embodiment. Since the antenna device 3 according to the third embodiment of the present disclosure does not include the support pole mounting unit 700 and the antenna mounting unit 60) of the first embodiment, the number of parts may be reduced.

Instead, in the tilt driving unit 400 of the antenna device 3 according to the third embodiment of the present disclosure, a first coupling block 421D coupled to the support pole 100 may be protrusively formed on the rear surface of the first tilt member 421, and a second coupling block 422D coupled to the rear surface of the antenna unit 200 may be protrusively formed on the front surface of the second tilt member 422.

The first coupling block 421D may be installed on the support pole 100 via bolts or welding, so that the rear surface of the first coupling block 421D may contact the front surface of the support pole 100, and the second coupling block 422D may be installed on the antenna unit 200 via bolts or welding, so that the front surface of the second coupling block 422D may contact the rear surface of the antenna unit 200.

In addition, in the tilt driving unit 400 of the antenna device 3 according to the third embodiment of the present disclosure, a first rotational coupling part 421E and a second rotational coupling part 421F may be protrusively formed on the first tilt member 421, a third rotational coupling part 422E and a fourth rotational coupling part 422F may be protrusively formed on the second tilt member 422, a fifth rotational coupling part 423E and a sixth rotational coupling part 423F may be protrusively formed on the third tilt member 423, and a seventh rotational coupling part 424E and an eighth rotational coupling part 424F may be protrusively formed on the fourth tilt member 424.

The first rotational coupling part 421E may be protrusively formed forward on the front left part of the first tilt member 421, and the second rotational coupling part 421F may be protrusively formed forward on the front right part of the first tilt member 421. Both ends of the first rotational coupling part 421E may be rotatably coupled to the left end of the first joint bar 411 and the left end of the third joint bar 413, respectively. Both ends of the second rotational coupling part 421F may be rotatably coupled to the right end of the first joint bar 411 and the right end of the third joint bar 413, respectively.

The third rotational coupling part 422E may be protrusively formed rearward on the rear left part of the second tilt member 422, and the fourth rotational coupling part 422F may be protrusively formed rearward on the rear right part of the second tilt member 422. The third rotational coupling part 422E and the fourth rotational coupling part 422F may be disposed between the first rotational coupling part 421E and the second rotational coupling part 421F. The left side of the third rotational coupling part 422E may contact the right side of the first rotational coupling part 421E, and the right side of the fourth rotational coupling part 422F may contact the left side of the second rotational coupling part 421F. The left side of the third rotational coupling part 422E may contact the right side of the seventh rotational coupling part 424E, and the right side of the fourth rotational coupling part 422F may contact the left side of the eighth rotational coupling part 424F. Both ends of the third rotational coupling part 422E may be rotatably coupled to the left end of the second joint bar 412 and the left end of the third joint bar 413, respectively. Both ends of the fourth rotational coupling part 422F may be rotatably coupled to the right end of the second joint bar 412 and the right end of the third joint bar 413, respectively.

The fifth rotational coupling part 423E may be protrusively formed forward on the front left part of the third tilt member 423, and the sixth rotational coupling part 423F may be protrusively formed forward on the front right part of the third tilt member 423. The fifth rotational coupling part 423E and the sixth rotational coupling part 423F may be disposed between the seventh rotational coupling part 424E and the eighth rotational coupling part 424F. The left side of the fifth rotational coupling part 423E may contact the right side of the seventh rotational coupling part 424E, and the right side of the sixth rotational coupling part 424F may contact the left side of the eighth rotational coupling part 424F. Both ends of the fifth rotational coupling part 423E may be rotatably coupled to the left end of the first joint bar 411 and the left end of the fourth joint bar 414, respectively. Both ends of the sixth rotational coupling part 423F may be rotatably coupled to the right end of the first joint bar 411 and the right end of the fourth joint bar 414, respectively.

The seventh rotational coupling part 424E may be protrusively formed rearward on the rear left part of the fourth tilt member 424, and the eighth rotational coupling part 424F may be protrusively formed rearward on the rear right part of the fourth tilt member 424. Both ends of the seventh rotational coupling part 424E may be rotatably coupled to the left end of the second joint bar 412 and the left end of the fourth joint bar 414, respectively. Both ends of the eighth rotational coupling part 424F may be rotatably coupled to the right end of the second joint bar 412 and the right end of the fourth joint bar 414, respectively.

Meanwhile, in the tilt driving unit 400 of the antenna device 3 according to the third embodiment of the present disclosure, the third joint bar 413 may pass through the nut member 430 from side to side, the screw bar 440 may pass through the nut member 430 and the third joint bar 413 from top to bottom, and the fourth joint bar 414 may pass through the tilt motor 450 from side to side.

Similarly, if the nut member 430 is installed on the fourth joint bar 414 and the tilt motor 450 is installed on the third joint bar 413, the fourth joint bar 414 may pass through the nut member 430 from side to side, the screw bar 440 may pass through the nut member 430 and the fourth joint bar 414 from top to bottom, and the third joint bar 413 may pass through the tilt motor 450 from side to side.

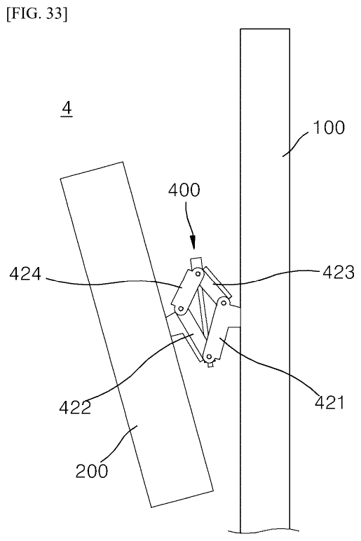

FIG. 33 is a view illustrating a state in which the tilt driving unit of the antenna device according to a fourth embodiment of the present disclosure tilts the antenna unit.

Referring to FIG. 33, the tilt driving unit 400 of the antenna device 4 according to the fourth embodiment of the present disclosure may be formed with a different structure from the tilt driving unit 400 of the antenna device 3 according to the third embodiment described above.

The specific structure of the tilt driving unit 400 of the antenna device 4 according to the fourth embodiment of the present disclosure will be described in detail below. However, for components of the tilt driving unit 400 of the antenna device 4 according to the fourth embodiment of the present disclosure that have the same function as those of the tilt driving unit 400 of the antenna device 3 according to the third embodiment described above, the same reference numerals will be assigned, and their detailed description will be omitted, with only the differences explained.

In the tilt driving unit 400 of the antenna device 3 according to the third embodiment described above, the length between both ends of each of the first tilt member 421, the second tilt member 422, the third tilt member 423, and the fourth tilt member 424 was formed to be the same length.

However, in the tilt driving unit 400 of the antenna device 3 according to the fourth embodiment of the present disclosure, the length between both ends of each of the first tilt member 421 and the second tilt member 422 may be formed to be the same first length, and the length between both ends of each of the third tilt member 423 and the fourth tilt member 424 may be formed to be the same second length. The first length may be formed longer than the second length, and the second length may be formed shorter than the first length. However, the second length may also be formed longer than the first length, and the first length may also be formed shorter than the second length. That is, the first length and the second length may be formed to be different lengths.

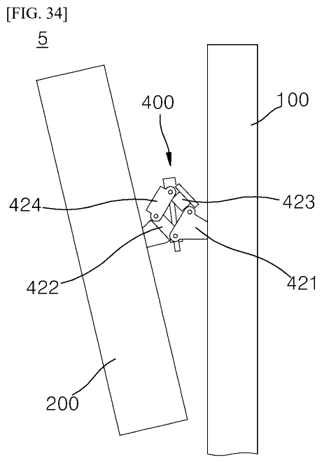

FIG. 34 is a view illustrating a state in which the tilt driving unit of the antenna device according to a fifth embodiment of the present disclosure tilts the antenna unit.

Referring to FIG. 34, the tilt driving unit 400 of the antenna device 5 according to the fifth embodiment of the present disclosure may be formed with a different structure from the tilt driving unit 400 of the antenna device 3 according to the third embodiment described above.

The specific structure of the tilt driving unit 400 of the antenna device 5 according to the fifth embodiment of the present disclosure will be described in detail below. However, for components of the tilt driving unit 400 of the antenna device 5 according to the fifth embodiment of the present disclosure that have the same function as those of the tilt driving unit 400 of the antenna device 3 according to the third embodiment described above, the same reference numerals will be assigned, and their detailed description will be omitted, with only the differences explained.

In the tilt driving unit 400 of the antenna device 3 according to the third embodiment described above, the length between both ends of each of the first tilt member 421, the second tilt member 422, the third tilt member 423, and the fourth tilt member 424 was formed to be the same length.

Similarly, in the tilt driving unit 400 of the antenna device 5 according to the fifth embodiment of the present disclosure, the length between both ends of each of the first tilt member 421, the second tilt member 422, the third tilt member 423, and the fourth tilt member 424 is formed to be the same length. However, the length between both ends of each of the first tilt member 421, the second tilt member 422, the third tilt member 423, and the fourth tilt member 424 in the tilt driving unit 400 of the antenna device 5 according to the fifth embodiment of the present disclosure is formed shorter than the length between both ends of each of the first tilt member 421, the second tilt member 422, the third tilt member 423, and the fourth tilt member 424 in the tilt driving unit 400 of the antenna device 3 according to the third embodiment described above.

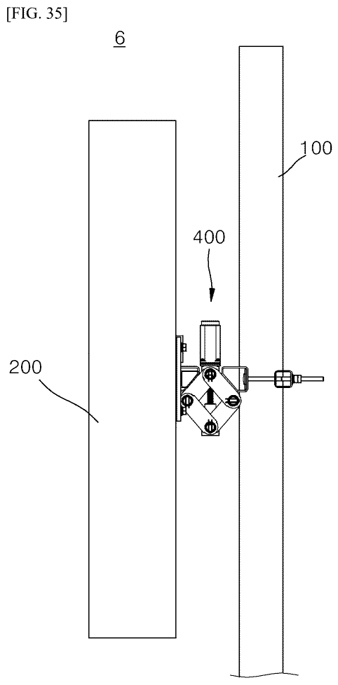

FIG. 35 is a view illustrating an antenna device according to a sixth embodiment of the present disclosure.

Referring to FIG. 35, the tilt driving unit 400 of the antenna device 6 according to the sixth embodiment of the present disclosure may be formed with a different structure from the tilt driving unit 400 of the antenna device 1 according to the first embodiment described above.

The specific structure of the tilt driving unit 400 of the antenna device 6 according to the sixth embodiment of the present disclosure will be described in detail below. However, for components of the tilt driving unit 400 of the antenna device 6 according to the sixth embodiment of the present disclosure that have the same function as those of the tilt driving unit 400 of the antenna device 1 according to the first embodiment described above, the same reference numerals will be assigned, and their detailed description will be omitted, with only the differences explained.

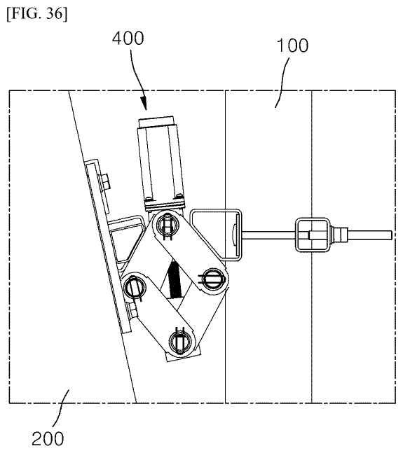

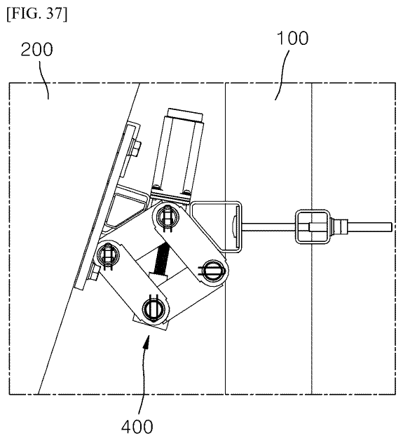

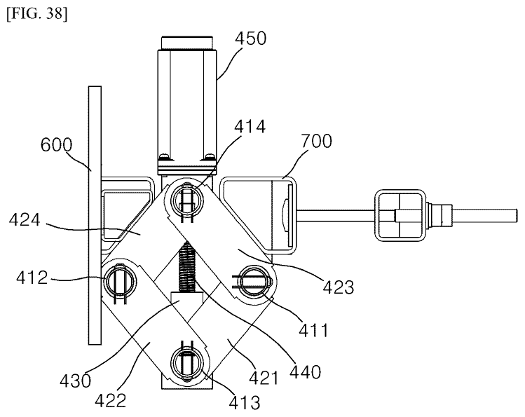

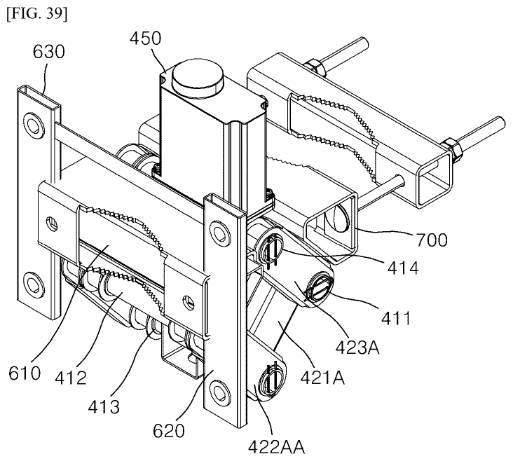

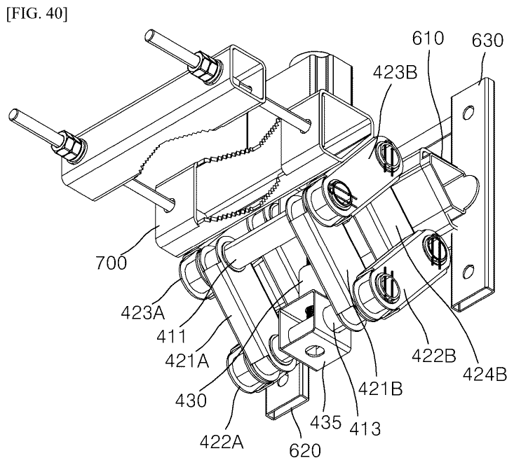

FIG. 36 is a view illustrating a state in which the tilt driving unit shown in FIG. 35 tilts the antenna unit so that the front surface of the antenna unit faces downward, FIG. 37 is a view illustrating a state in which the tilt driving unit shown in FIG. 35 tilts the antenna unit so that the front surface of the antenna unit faces upward, FIG. 38 is an enlarged view illustrating the tilt driving unit shown in FIG. 35, FIG. 39 is a front perspective view of FIG. 38, and FIG. 40 is a rear bottom perspective view of FIG. 38.

Referring to FIGS. 36 to 40, in the tilt driving unit 400 of the antenna device 1 according to the first embodiment described above, the first joint bar 411 was coupled to the support pole mounting unit 700, and the second joint bar 422 was coupled to the antenna mounting unit 600.

However, in the tilt driving unit 400 of the antenna device 6 according to the sixth embodiment of the present disclosure, the first joint bar 411 is not coupled to the support pole mounting unit 700, and the second joint bar 422 is not coupled to the antenna mounting unit 600.

Instead, in the tilt driving unit 400 of the antenna device 6 according to the sixth embodiment of the present disclosure, the rear surface of the third tilt member 423 may be coupled to the support pole mounting unit 700, and the front surface of the fourth tilt member 424 may be coupled to the antenna mounting unit 600. The rear surface of the third tilt member 423 may be coupled to the support pole mounting unit 700 via bolts or welding, and the front surface of the fourth tilt member 424 may be coupled to the antenna mounting unit 600 via bolts or welding.

The part of the support pole mounting unit 700 coupled to the rear surface of the third tilt member 423 may be formed as an inclined surface, and the part of the antenna mounting unit 600 coupled to the front surface of the fourth tilt member 424 may be formed as an inclined surface. The inclined surface formed on the support pole mounting unit 700 may be formed on the horizontal bracket forming the front part of the mounting clamp 700, and the inclined surface formed on the antenna mounting unit 600 may be formed on the horizontal bracket 610.

In the tilt driving unit 400 of the antenna device 6 according to the sixth embodiment of the present disclosure, since the support pole mounting unit 700 is coupled to the third tilt member 423, the load acting from the support pole 100 may be dispersed to the first joint bar 411 and the fourth joint bar 414, and since the antenna mounting unit 600 is coupled to the fourth tilt member 424, the load acting from the antenna unit 200 may be dispersed to the second joint bar 412 and the fourth joint bar 414, thereby facilitating the tilt operation of the tilt driving unit 400.

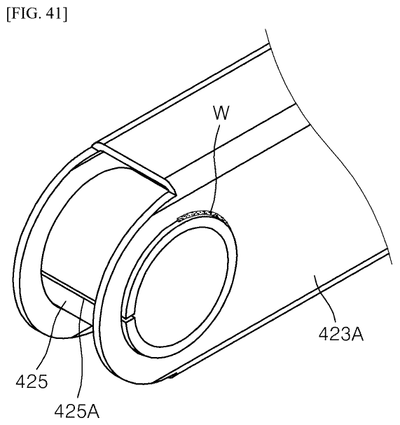

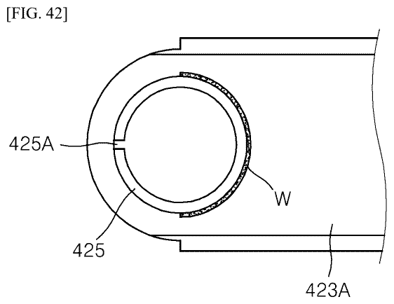

FIG. 41 is a perspective view illustrating another embodiment of the bushing shown in FIG. 6, and FIG. 42 is a side view of FIG. 41.

Referring to FIGS. 41 and 42, while in the tilt driving unit 400 of the antenna device 1 according to the first embodiment described above, a bushing 425 was installed at both ends of each of the plurality of tilt members 421, 422, 423 and 424 as referenced in FIG. 6, in this embodiment, the bushing 425 may have a cutout portion 425A formed by cutting one side. At least a portion of the opposite side of the cutout portion 425A of the bushing 425 may be circularly welded W to each of the plurality of tilt members 421, 422, 423 and 424. FIG. 42 illustrates a bushing 425 welded W in a semicircular shape as an example of a circular shape.

Therefore, the bushings 425 installed at both ends of each of the plurality of tilt members 421, 422, 423 and 424 may move elastically due to the cutout portion 425A in the parts not welded W to the plurality of tilt members 421, 422, 423 and 424. This allows the plurality of tilt members 421, 422, 423 and 424 to rotate smoothly with respect to the plurality of joint bars 411, 412, 413 and 414, thereby facilitating the tilt operation of the tilt driving unit 400.

Meanwhile, in the tilt driving unit 400 of the foregoing embodiments, the plurality of joint bars 411, 412, 413 and 414 were coupled to the plurality of tilt members 421, 422, 423 and 424 through a plurality of clips C1, C2, C3 and C4. However, instead of the plurality of clips C1, C2, C3 and C4, they may be coupled to the plurality of tilt members 421, 422, 423 and 424 through a plurality of snap rings. This will be described below with reference to FIGS. 43 and 44.

FIG. 43 is a view illustrating another embodiment of the tilt driving unit shown in FIG. 36, and FIG. 44 is an exploded view illustrating the fourth snap ring of the fourth joint bar shown in FIG. 43.

Referring to FIGS. 43 and 44, after the 1-1 tilt member 421A, the 1-2 tilt member 421B, the 3-1 tilt member 423A, and the 3-2 tilt member 423B are rotatably coupled to the first joint bar 411, a first snap ring SR1 may be installed at each of both ends of the first joint bar 411. The first snap ring SR1 may prevent the first joint bar 411 from detaching from the 1-1 tilt member 421A, the 1-2 tilt member 421B, the 3-1 tilt member 423A, and the 3-2 tilt member 423B.

After the 2-1 tilt member 422A, the 2-2 tilt member 422B, the 4-1 tilt member 424A, and the 4-2 tilt member 424B are rotatably coupled to the second joint bar 412, a second snap ring SR2 may be installed at each of both ends of the second joint bar 412. The second snap ring SR2 may prevent the second joint bar 412 from detaching from the 2-1 tilt member 422A, the 2-2 tilt member 422B, the 4-1 tilt member 424A, and the 4-2 tilt member 424B.

After the 1-1 tilt member 421A, the 1-2 tilt member 421B, the 2-1 tilt member 422A, and the 2-2 tilt member 422B are rotatably coupled to the third joint bar 413, a third snap ring SR3 may be installed at each of both ends of the third joint bar 413. The third snap ring SR3 may prevent the third joint bar 413 from detaching from the 1-1 tilt member 421A, the 1-2 tilt member 421B, the 2-1 tilt member 422A, and the 2-2 tilt member 422B.

After the 3-1 tilt member 423A, the 3-2 tilt member 423B, the 4-1 tilt member 424A, and the 4-2 tilt member 424B are rotatably coupled to the fourth joint bar 414, a fourth snap ring SR4 may be installed at each of both ends of the fourth joint bar 414. The fourth snap ring SR4 may prevent the fourth joint bar 414 from detaching from the 3-1 tilt member 423A, the 3-2 tilt member 423B, the 4-1 tilt member 424A, and the 4-2 tilt member 424B.

Specifically, as referenced in FIG. 44, a snap ring coupling groove 417 may be formed on the outer circumferential surface of the end of the fourth joint bar 414. The snap ring coupling groove 417 may be formed on the outer circumferential surface of each of both ends of the fourth joint bar 414. The fourth snap ring SR4 may be coupled to the snap ring coupling groove 417 to couple the fourth joint bar 414 to the 3-1 tilt member 423A.

Similarly, the fourth joint bar 414, a snap ring coupling groove 417 may also be formed on the outer circumferential surface of both ends of each of the first joint bar 411, the second joint bar 412, and the third joint bar 413. That is, a snap ring coupling groove 417 may be formed on the outer circumferential surface of both ends of the plurality of joint bars 411, 412, 413 and 414, and a plurality of snap rings SR1, SR2, SR3 and SR4 may each be coupled to the snap ring coupling groove 417 formed on the outer circumferential surface of both ends of the plurality of joint bars 411, 412, 413 and 414 to couple the plurality of joint bars 411, 412, 413 and 414 to the plurality of tilt members 421, 422, 423 and 424 respectively.

The plurality of snap rings SR1, SR2, SR3 and SR4 may be formed in various shapes such as C-shape, E-shape, etc.

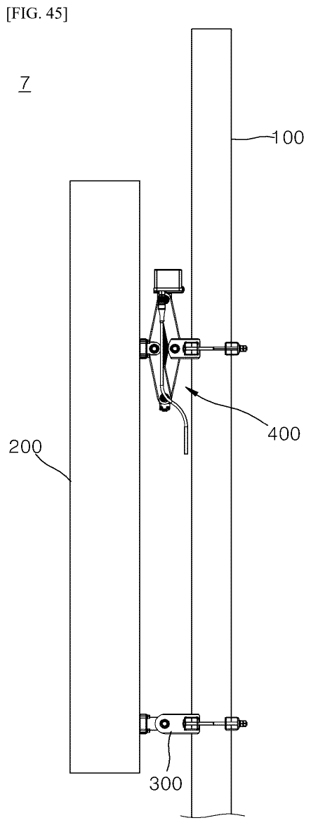

FIG. 45 is a side view illustrating an antenna device according to a seventh embodiment of the present disclosure.

Referring to FIG. 45, the tilt driving unit 400 of the antenna device 7 according to the seventh embodiment of the present disclosure may be formed with a different structure from the tilt driving unit 400 of the antenna device 1 according to the first embodiment described above.

The specific structure of the tilt driving unit 400 of the antenna device 7 according to the seventh embodiment of the present disclosure will be described in detail below. However, for components of the tilt driving unit 400 of the antenna device 7 according to the seventh embodiment of the present disclosure that have the same function as those of the tilt driving unit 400 of the antenna device 1 according to the first embodiment described above, the same reference numerals will be assigned, and their detailed description will be omitted, with only the differences explained.

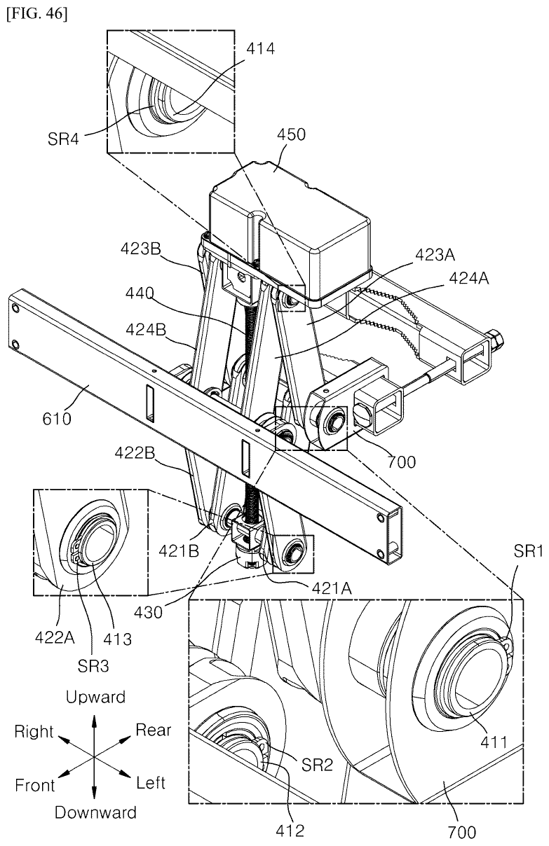

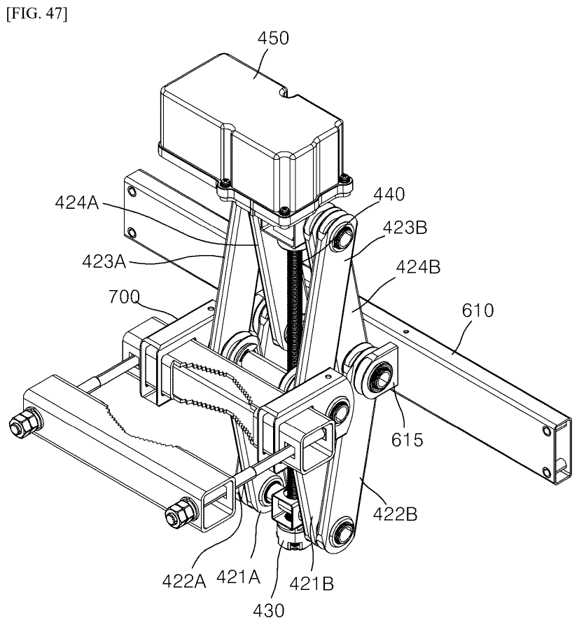

FIG. 46 is a front perspective view illustrating the tilt driving unit shown in FIG. 45, and FIG. 47 is a rear perspective view illustrating the tilt driving unit shown in FIG. 45.

Referring to FIGS. 46 and 47, the tilt driving unit 400 of the antenna device 7 according to the seventh embodiment of the present disclosure may be formed with a slimmer width compared to the tilt driving unit 400 of the antenna device 1 according to the first embodiment described above.

That is, the left-right width of each of the plurality of tilt members 421, 422, 423 and 424 of the tilt driving unit 400 of the antenna device 7 according to the seventh embodiment of the present disclosure may be formed slimmer than the left-right width of each of the plurality of tilt members 421, 422, 423 and 424 of the tilt driving unit 400 of the antenna device 1 according to the first embodiment described above.

Accordingly, the left-right spacing between the pair of coupling parts 615 formed on the horizontal bracket 610 of the antenna device 7 according to the seventh embodiment of the present disclosure may be narrower than the left-right spacing between the pair of coupling parts 615 formed on the horizontal bracket 610 of the antenna device 1 according to the first embodiment described above. In addition, the left-right spacing between the two sides of the support pole mounting unit 700 of the antenna device 7 according to the seventh embodiment of the present disclosure that are coupled to both ends of the first joint bar 411, respectively, may be narrower than the left-right spacing between the two sides of the support pole mounting unit 700 of the antenna device 1 according to the first embodiment described above that are coupled to both ends of the first joint bar 411, respectively.

In addition, the left-right width of each of the pair of coupling parts 615 formed on the horizontal bracket 610 of the antenna device 7 according to the seventh embodiment of the present disclosure may be formed slimmer than the left-right width of each of the pair of coupling parts 615 formed on the horizontal bracket 610 of the antenna device 1 according to the first embodiment described above.

In addition, the left-right width of the two sides of the support pole mounting unit 700 of the antenna device 7 according to the seventh embodiment of the present disclosure that are coupled to both ends of the first joint bar 411, respectively, may be formed slimmer than the left-right width of the two sides of the support pole mounting unit 700 of the antenna device 1 according to the first embodiment described above that are coupled to both ends of the first joint bar 411, respectively.

In addition, while in the antenna device 1 according to the first embodiment described above, a pair of vertical brackets 620 and 630 were coupled to both ends of the horizontal bracket 610, respectively, and the pair of vertical brackets 620 and 630 were fastened to the rear surface of the antenna unit 200 via bolts or screws, in the antenna device 7 according to the seventh embodiment of the present disclosure, the pair of vertical brackets 620 and 630 are not coupled to both ends of the horizontal bracket 610, and both ends of the horizontal bracket 610 may be fastened to the rear surface of the antenna unit 200 via bolts or screws.

In addition, while the tilt driving unit 400 of the antenna device 1 according to the first embodiment described above included a plurality of connecting bars 461, 462, 463 and 464, the tilt driving unit 400 of the antenna device 7 according to the seventh embodiment of the present disclosure may not include the plurality of connecting bars 461, 462, 463 and 464.

In addition, while in the tilt driving unit 400 of the antenna device 1 according to the first embodiment described above, a plurality of clips C1, C2, C3 and C4 were installed at both ends of each of the plurality of joint bars 411, 412, 413 and 414, in the tilt driving unit 400 of the antenna device 7 according to the seventh embodiment of the present disclosure, a plurality of snap rings SR1, SR2, SR3 and SR4 may be installed at both ends of each of the plurality of joint bars 411, 412, 413 and 414. The structure in which the plurality of snap rings SR1, SR2, SR3 and SR4 are installed at both ends of each of the plurality of joint bars 411, 412, 413 and 414 in the tilt driving unit 400 of the antenna device 7 according to the seventh embodiment of the present disclosure may be the same as the structure in which the plurality of snap rings SR1, SR2, SR3 and SR4 are installed at both ends of each of the plurality of joint bars 411, 412, 413 and 414 as described with reference to FIGS. 43 and 44.

Meanwhile, referring to FIG. 45, the lower link unit 300 of the antenna device 7 according to the seventh embodiment of the present disclosure may be formed with a different structure from the lower link unit 300 of the antenna device 1 according to the first embodiment described above.

The specific structure of the lower link unit 300 of the antenna device 7 according to the seventh embodiment of the present disclosure will be described in detail below. However, for components of the lower link unit 300 of the antenna device 7 according to the seventh embodiment of the present disclosure that have the same function as those of the lower link unit 300 of the antenna device 1 according to the first embodiment described above, the same reference numerals will be assigned, and their detailed description will be omitted, with only the differences explained.

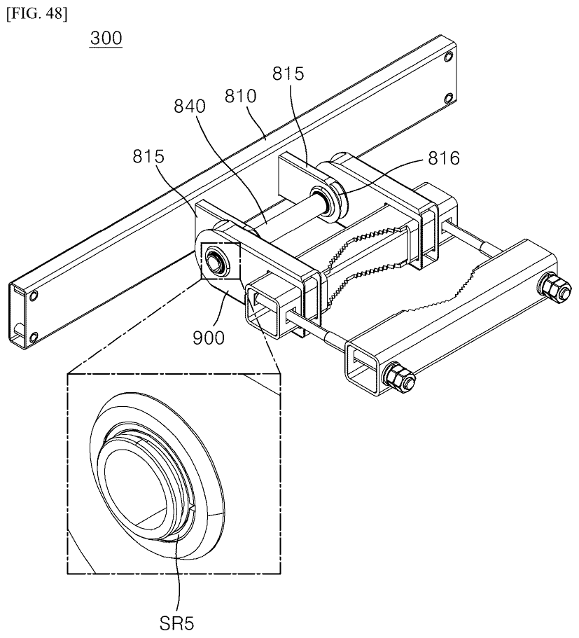

FIG. 48 is a rear perspective view illustrating the lower link unit shown in FIG. 45.

Referring to FIG. 48, the lower link unit 300 of the antenna device 7 according to the seventh embodiment of the present disclosure may be formed with a slimmer left-right width compared to the lower link unit 300 of the antenna device 1 according to the first embodiment described above.

The left-right spacing between the pair of coupling parts 815 formed on the horizontal bracket 810 of the lower link unit 300 of the antenna device 7 according to the seventh embodiment of the present disclosure may be narrower than the left-right spacing between the pair of coupling parts 615 (refer to FIG. 16) formed on the horizontal bracket 810 (refer to FIG. 16) of the lower link unit 300 (refer to FIG. 16) of the antenna device 1 according to the first embodiment described above. In addition, the left-right spacing between the two sides of the support pole mounting unit 900 of the antenna device 7 according to the seventh embodiment of the present disclosure that are coupled to both ends of the fifth joint bar 840, respectively, may be narrower than the left-right spacing between the two sides of the support pole mounting unit 900 (refer to FIG. 16) of the antenna device 1 according to the first embodiment described above that are coupled to both ends of the fifth joint bar 840 (refer to FIG. 16), respectively.

In addition, the left-right width of each of the pair of coupling parts 815 formed on the horizontal bracket 810 of the lower link unit 300 of the antenna device 7 according to the seventh embodiment of the present disclosure may be formed slimmer than the left-right width of each of the pair of coupling parts 815 formed on the horizontal bracket (810) of the lower link unit 300 of the antenna device 1 according to the first embodiment described above.

In addition, the left-right width of the two sides of the support pole mounting unit 900 of the antenna device 7 according to the seventh embodiment of the present disclosure that are coupled to both ends of the fifth joint bar 840, respectively, may be formed slimmer than the left-right width of the two sides of the support pole mounting unit 900 of the antenna device 1 according to the first embodiment described above that are coupled to both ends of the fifth joint bar 840, respectively.

In addition, while in the lower link unit 300 of the antenna device 1 according to the first embodiment described above, a pair of vertical brackets 820 and 830 were coupled to both ends of the horizontal bracket 810, respectively, and the pair of vertical brackets 820 and 830 were fastened to the rear surface of the antenna unit 200 via bolts or screws, in the lower link unit 300 of the antenna device 7 according to the seventh embodiment of the present disclosure, the pair of vertical brackets 820 and 830 are not coupled to both ends of the horizontal bracket 810, and both ends of the horizontal bracket 810 may be fastened to the rear surface of the antenna unit 200 via bolts or screws.

In addition, while in the lower link unit 300 of the antenna device 1 according to the first embodiment described above, a fifth clip C5 (refer to FIG. 16) was installed at both ends of the fifth joint bar 840, in the lower link unit 300 of the antenna device 1 according to the seventh embodiment of the present disclosure, a fifth snap ring SR5 may be installed at both ends of the fifth joint bar 840. The structure in which the fifth snap ring SR5 is installed at both ends of the fifth joint bar 840 in the lower link unit 300 of the antenna device 7 according to the seventh embodiment of the present disclosure may be installed in the same structure as the plurality of snap rings SR1, SR2, SR3 and SR4 described with reference to FIGS. 43 and 44, which are installed at both ends of the plurality of joint bars 411, 412, 413 and 414. The fifth snap ring SR5 may prevent the fifth joint bar 840 from detaching from the pair of coupling parts 815 and the support pole mounting unit 900.

As described above, the antenna device according to the embodiments of the present disclosure may facilitate the operation of the tilt driving unit 400 by reducing the weight of the tilt driving unit 400 while ensuring sufficient rigidity, because the plurality of joint bars 411, 412, 413 and 414 constituting the tilt driving unit 400 for tilting the antenna unit 200 are formed in a hollow pipe shape.

In addition, in the antenna device according to the embodiments of the present disclosure, an operator may manually tilt the antenna unit 200 by rotating the manual tilt adjustment member 445, and may automatically tilt the antenna unit 200 by the operation of the tilt motor 450 by coupling the rotation axis of the tilt motor 450 to the manual tilt adjustment member 445.

In addition, in the antenna device according to the embodiments of the present disclosure, the operation of the tilt driving unit 400 may be facilitated and operating noise may be reduced, because at least one bushing 425 is coupled to both ends of each of the plurality of tilt members 421, 422, 423 and 424, and the plurality of joint bars 411, 412, 413 and 414 are rotatably coupled to the at least one bushing 425.

In addition, in the antenna device according to the embodiments of the present disclosure, since the at least one bushing 425 has a cutout portion 425A formed by cutting one side, and at least a portion of the opposite side of the cutout portion 425A of the at least one bushing 425 is circularly welded to each of the plurality of tilt members 421, 422, 423 and 424, when the plurality of tilt members 421, 422, 423 and 424 rotate, the at least one bushing 425 elastically moves around the cutout portion 425A, thereby facilitating the rotational operation of the plurality of tilt members 421, 422, 423 and 424.

Additionally, the antenna device according to the embodiments of the present disclosure may be robustly coupled to the support pole 100 against external forces such as wind, because if the vertical length of the antenna unit 200 is relatively long, the antenna unit 200 may be installed on the support pole 100 through the lower link unit 300 and the tilt driving unit 400, and if the vertical length of the antenna unit 200 is relatively short, the antenna unit 200 may be installed on the support pole 100 only through the tilt driving unit 400.

Furthermore, the antenna device according to the embodiments of the present disclosure may tilt the antenna unit 200 with a simple structure, because the tilt driving unit 400 may be directly installed on the support pole 100 and the antenna unit 200, respectively, without the existing support pole mounting unit 700 installed on the support pole 100 and the existing antenna mounting unit 600 installed on the antenna unit 200.

Those skilled in the art to which the present disclosure pertains will understand that the present disclosure may be implemented in other specific forms without changing its technical spirit or essential features. Therefore, the embodiments described above should be understood as illustrative in all respects and not restrictive. The scope of the present disclosure is indicated by the claims described below rather than the detailed description above, and all changes or modified forms derived from the meaning and scope of the claims and their equivalents should be construed as being included in the scope of the present disclosure.

### INDUSTRIAL APPLICABILITY

The present disclosure provides an antenna device that may facilitate the operation of the tilt driving unit by reducing the weight of the tilt driving unit for tilting the antenna unit while ensuring sufficient rigidity.

1. An antenna device, comprising:
an antenna unit; and
a tilt driving unit having a plurality of tilt members configured to tilt the antenna unit when rotated, and a plurality of joint bars configured to rotatably couple both ends of each of the plurality of tilt members, the tilt driving unit configured to couple the antenna unit to a support pole,
wherein the plurality of joint bars are formed in a hollow pipe shape.

2. The antenna device of claim 1, wherein at least one bushing is coupled to both ends of each of the plurality of tilt members, and the plurality of joint bars are rotatably coupled to the at least one bushing, respectively.

3. The antenna device of claim 1, further comprising a plurality of fixing fasteners configured to couple both ends of the plurality of joint bars to the plurality of tilt members, respectively.

4. The antenna device of claim 3, wherein clip through-holes are formed at both ends of the plurality of joint bars, and the plurality of fixing fasteners are formed as a plurality of clips that each pass through the clip through-holes formed at both ends of the plurality of joint bars to couple the plurality of joint bars to the plurality of tilt members, respectively.

5. The antenna device of claim 1, wherein the plurality of joint bars comprise:
a first joint bar;
a second joint bar spaced forward from the first joint bar and arranged parallel to the first joint bar;
a third joint bar spaced upward or downward between the first joint bar and the second joint bar and arranged parallel to the first joint bar and the second joint bar; and
a fourth joint bar spaced in the opposite direction to the third joint bar between the first joint bar and the second joint bar and arranged parallel to the first joint bar, the second joint bar, and the third joint bar.

6. The antenna device of claim 5, further comprising a support pole mounting unit coupled to the support pole, and an antenna mounting unit coupled to the antenna unit, wherein the first joint bar is coupled to the support pole mounting unit, and the second joint bar is coupled to the antenna mounting unit.

7. The antenna device of claim 5, wherein the plurality of tilt members comprise:
a first tilt member whose both ends are rotatably coupled to the first joint bar and the third joint bar, respectively;
a second tilt member whose both ends are rotatably coupled to the second joint bar and the third joint bar, respectively;
a third tilt member whose both ends are rotatably coupled to the first joint bar and the fourth joint bar, respectively; and
a fourth tilt member whose both ends are rotatably coupled to the second joint bar and the fourth joint bar, respectively.

8. The antenna device of claim 7, wherein the tilt driving unit further comprises:
a nut member disposed on either the third joint bar or the fourth joint bar; and
a screw bar vertically fastened to the nut member, the screw bar rotating the first tilt member, the second tilt member, the third tilt member, and the fourth tilt member to tilt the antenna unit when rotated.

9. The antenna device of claim 8, wherein a first coupling frame in the shape of a hollow pipe is disposed in the nut member, the first coupling frame having a first through-hole through which the one of the aforementioned joint bars passes, formed on each side, and a second through-hole through which the screw bar passes, formed on the upper and lower sides, respectively, and a third through-hole through which the screw bar passes, is formed in the one of the aforementioned joint bars.

10. The antenna device of claim 8, wherein the tilt driving unit further comprises:
a mounting bracket disposed on the other of the third joint bar and the fourth joint bar; and
a manual tilt adjustment member rotatably disposed on the mounting bracket and coupled to one end of the screw bar.

11. The antenna device of claim 10, wherein the tilt driving unit further comprises a tilt motor mounted on the mounting bracket, whose rotation axis is connected to the manual tilt adjustment member to rotate the screw bar.

12. The antenna device of claim 1, wherein the plurality of tilt members are formed in a plate shape.

13. The antenna device of claim 1, wherein the plurality of joint bars comprise:
a first joint bar;
a second joint bar spaced forward from the first joint bar and arranged parallel to the first joint bar; and
a third joint bar spaced upward or downward between the first joint bar and the second joint bar and arranged parallel to the first joint bar and the second joint bar.

14. The antenna device of claim 13, further comprising a support pole mounting unit coupled to the support pole, and an antenna mounting unit coupled to the antenna unit, wherein the first joint bar is coupled to the support pole mounting unit, and the second joint bar is coupled to the antenna mounting unit.

15. The antenna device of claim 13, wherein the plurality of tilt members comprise:
a first tilt member whose both ends are rotatably coupled to the first joint bar and the third joint bar, respectively; and
a second tilt member whose both ends are rotatably coupled to the second joint bar and the third joint bar, respectively.

16. The antenna device of claim 15, wherein,
the first tilt member comprises a 1-1 tilt member whose both ends are rotatably coupled to one end of the first joint bar and one end of the third joint bar, respectively, and a 1-2 tilt member whose both ends are rotatably coupled to the other end of the first joint bar and the other end of the third joint bar, respectively; and
the second tilt member comprises a 2-1 tilt member whose both ends are rotatably coupled to one end of the second joint bar and one end of the third joint bar, respectively, and a 2-2 tilt member whose both ends are rotatably coupled to the other end of the second joint bar and the other end of the third joint bar, respectively.

17. The antenna device of claim 16, wherein the tilt driving unit further comprises:
a first connecting plate from which the 1-1 tilt member and the 1-2 tilt member are bent and formed; and
a second connecting plate from which the 2-1 tilt member and the 2-2 tilt member are bent and formed.

18. The antenna device of claim 15, wherein the tilt driving unit further comprises:
a nut member disposed on the third joint bar; and
a screw bar vertically fastened to the nut member, the screw bar rotating the first tilt member and the second tilt member to tilt the antenna unit when rotated.

19. The antenna device of claim 18, wherein the tilt driving unit further comprises:
a mounting bracket having a first guide hole formed on its side for guiding the third joint bar up and down when the screw bar rotates; and
a manual tilt adjustment member rotatably disposed on the upper surface of the mounting bracket and coupled to one end of the screw bar.

20. The antenna device of claim 19, wherein the tilt driving unit further comprises a tilt motor mounted on the upper surface of the mounting bracket, whose rotation axis is connected to the manual tilt adjustment member to rotate the screw bar.

21. The antenna device of claim 1, wherein the plurality of tilt members are formed in a block shape.

22. The antenna device of claim 1, wherein the plurality of joint bars comprise:
a first joint bar;
a second joint bar spaced forward from the first joint bar and arranged parallel to the first joint bar;
a third joint bar spaced upward or downward between the first joint bar and the second joint bar and arranged parallel to the first joint bar and the second joint bar; and
a fourth joint bar spaced in the opposite direction to the third joint bar between the first joint bar and the second joint bar and arranged parallel to the first joint bar, the second joint bar, and the third joint bar.

23. The antenna device of claim 22, wherein the plurality of tilt members comprise:
a first tilt member whose both ends are rotatably coupled to the first joint bar and the third joint bar, respectively;
a second tilt member whose both ends are rotatably coupled to the second joint bar and the third joint bar, respectively;
a third tilt member whose both ends are rotatably coupled to the first joint bar and the fourth joint bar, respectively; and
a fourth tilt member whose both ends are rotatably coupled to the second joint bar and the fourth joint bar, respectively.

24. The antenna device of claim 23, wherein a first coupling block coupled to the support pole is protrusively formed on the rear surface of the first tilt member, and a second coupling block coupled to the rear surface of the antenna unit is protrusively formed on the front surface of the second tilt member.

25. The antenna device of claim 23, wherein,
on the first tilt member, a first rotational coupling part whose both ends are rotatably coupled to one end of the first joint bar and one end of the third joint bar, respectively, is protrusively formed, and a second rotational coupling part whose both ends are rotatably coupled to the other end of the first joint bar and the other end of the third joint bar, respectively, is protrusively formed;
on the second tilt member, a third rotational coupling part whose both ends are rotatably coupled to one end of the second joint bar and one end of the third joint bar, respectively, is protrusively formed, and a fourth rotational coupling part whose both ends are rotatably coupled to the other end of the second joint bar and the other end of the third joint bar, respectively, is protrusively formed;
on the third tilt member, a fifth rotational coupling part whose both ends are rotatably coupled to one end of the first joint bar and one end of the fourth joint bar, respectively, is protrusively formed, and a sixth rotational coupling part whose both ends are rotatably coupled to the other end of the first joint bar and the other end of the fourth joint bar, respectively, is protrusively formed; and
on the fourth tilt member, a seventh rotational coupling part whose both ends are rotatably coupled to one end of the second joint bar and one end of the fourth joint bar, respectively, is protrusively formed, and an eighth rotational coupling part whose both ends are rotatably coupled to the other end of the second joint bar and the other end of the fourth joint bar, respectively, is protrusively formed.

26. The antenna device of claim 23, wherein the tilt driving unit further comprises:
a nut member disposed on either the third joint bar or the fourth joint bar; and
a screw bar vertically fastened to the nut member, the screw bar rotating the first tilt member, the second tilt member, the third tilt member, and the fourth tilt member to tilt the antenna unit when rotated.

27. The antenna device of claim 7, further comprising a support pole mounting unit coupled to the support pole, and an antenna mounting unit coupled to the antenna unit, wherein the rear surface of the third tilt member is coupled to the support pole mounting unit, and the front surface of the fourth tilt member is coupled to the antenna mounting unit.
